(19) United States
(12) Patent Application Publication
(10) Pub. No.: US 2025/0028504 A1
(43) Pub. Date: Jan. 23, 2025

(54) MULTIPLICATION CIRCUITRY, SYSTEM, CHIP-CONTAINING PRODUCT, AND COMPUTER-READABLE MEDIUM

(71) Applicant: Arm Limited, Cambridge, Cambridgeshire (GB)

(72) Inventors: Nicholas Andrew PFISTER, Austin, TX (US); Vignesh Devidas KUDVA, Cambridge (GB)

(21) Appl. No.: 18/356,618

(22) Filed: Jul. 21, 2023

(51) Int. Cl. G06F 7/523; G06F 7/50

(52) U.S. Cl. CPC G06F 7/523; G06F 7/50

(57) ABSTRACT

Multiplication circuitry comprises adder sub-arrays which each add partial products derived from first/second operands. Sub-array result values generated by the adder sub-arrays are added in a result assembly addition to generate at least one multiplication result value representing a result of signed multiplication of the first operand and the second operand. Sign extension emulation is performed for a sign-extension-emulated sub-array result value added in the result assembly addition, by applying a default zero extension to the sign-extension-emulated sub-array result value regardless of its sign and emulating an effect of sign extending the sign-extension-emulated sub-array result value using another of the assembled values. Another example of multiplication circuitry applies default zero extension to a third signed operand being added to a product of first/second signed operands, and emulates sign extension of the third signed operand by adjusting one of the partial products derived from the first/second signed operands.

### BACKGROUND

### Technical Field

The present technique relates to the field of data processing.

### Technical Background

A processor may have logic circuitry for implementing various arithmetic or logical operations. One arithmetic operation to be supported by a processor may be a multiplication operation. While the arithmetic operation for the multiplication operation is well-defined, there is design choice to be made in how to implement hardware circuit logic for performing that operation within a processor. Design decisions made by the circuit designer may have an impact on processing performance and/or energy efficiency.

### SUMMARY

At least some examples of the present technique provide multiplication circuitry comprising:
a plurality of adder sub-arrays, each adder array to add a respective set of partial products to generate one or more sub-array result values representing a result of signed multiplication of a respective pair of portions of bits selected from a first operand and a second operand, the plurality of adder sub-arrays comprising separate instances of hardware circuitry, the plurality of adder sub-arrays having at least two separate enable control signals for independently controlling whether at least two subsets of the adder sub-arrays are enabled or disabled; and
a result assembly adder array to perform a result assembly addition to add a plurality of assembled values including the sub-array result values generated by the plurality of adder sub-arrays, to generate at least one multiplication result value representing a result of signed multiplication of the first operand and the second operand;
wherein for a sign-extension-emulated sub-array result value being added in the result assembly addition, the result assembly adder array is configured to perform sign extension emulation by:
   applying a default zero extension to the sign-extension-emulated sub-array result value regardless of a sign of the sign-extension-emulated sub-array result value, and
   performing the result assembly addition with at least one other of the plurality of assembled values having a value that, when added in the result assembly addition, emulates an effect of sign extending the sign-extension-emulated sub-array result value up to a bit position corresponding to the most significant bit of the at least one multiplication result value.

At least some examples of the present technique provide multiplication circuitry comprising:
partial product selection circuitry to select a plurality of partial products based on a first signed operand and a second signed operand; and
an adder array to add the plurality of partial products and a third signed operand; in which:
the adder array is configured to apply a default zero extension to the third signed operand regardless of a sign of the third signed operand, and the partial product selection circuitry is configured to adjust one of the partial products added by the adder array to emulate an effect of sign extending the third signed operand.

At least some examples provide a system comprising: the multiplication circuitry according to either of the examples described above, implemented in at least one packaged chip; at least one system component; and a board, wherein the at least one packaged chip and the at least one system component are assembled on the board.

At least some examples provide a chip-containing product comprising the system described above assembled on a further board with at least one other product component.

At least some examples of the present technique provide a non-transitory computer-readable medium to store computer-readable code for fabrication of the multiplication circuitry of either of the examples described above.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a data processing apparatus;

FIG. 2 illustrates an example of multiplication circuitry;

FIG. 3 illustrates sign extension headers for partial products added by an adder array;

FIG. 4 illustrates an example of partial product additions for a signed multiply-add operation in which a third signed operand is added to a product of a first signed operand and a second signed operand;

FIG. 5 illustrates emulation of sign extension for the third signed operand;

FIG. 6 illustrates adjustment of a sign extension header for a least significant partial product based on a sign of the third signed operand;

FIG. 7 illustrates addition of the partial products and third signed operand with sign extension of the third signed operand emulated by an adjusted sign extension header for the least significant partial product;

FIG. 8 is a flow diagram showing a method of performing a signed multiply-add operation;

FIG. 9 illustrates another example of multiplication circuitry comprising adder sub-arrays and a result assembly adder array;

FIG. 10 illustrates an example of the sub-arrays in more detail;

FIG. 11 is a flow diagram showing a method of using sign extension emulation in a result assembly addition of sub-array result values;

FIGS. 12 to 21 illustrate, for a first example of a result assembly addition, use of first, second and third types of sign extension emulation to avoid costly sign extensions on sub-array result values;

FIGS. 22 to 31 illustrate, for a second example of a result assembly addition, use of first, second and third types of sign extension emulation to avoid costly sign extensions on sub-array result values; and

FIG. 32 illustrates an example of a system and chip-containing product.

### DESCRIPTION OF EXAMPLES

In some examples, multiplication circuitry comprises two or more adder sub-arrays each to add a respective set of partial products to generate one or more sub-array result values representing a result of signed multiplication of a respective pair of portions of bits selected from a first operand and a second operand. Each adder sub-array comprises a separate instance of hardware circuitry. The adder sub-arrays have at least two separate enable control signals for independently controlling whether at least two subsets of adder sub-arrays are enabled or disabled. This approach can be useful to support multiplication operations on portions of the first operand and second operand corresponding to different data types, for example.

A result assembly adder array is provided to perform a result assembly addition to add a plurality of assembled values including the sub-array result values generated by the plurality of adder sub-arrays, to generate at least one multiplication result value representing a result of signed multiplication of the first operand and the second operand. Hence, as well as being operable independently (with unused adder arrays being able to be placed in a power saving state using the independent enable/disable control), the adder sub-arrays can also be used in a cooperative mode so that the respective sub-array result values are added together by the result assembly adder array, to produce at least one multiplication result value which represents a result of signed multiplication of the first operand and the second operand. The at least one multiplication result value may provide a wider multiplication result (with a greater number of bits) than the individual results produced by each adder array. In some cases, the result assembly adder array may generate a plurality of multiplication result values in a redundant form, e.g. generating a carry term and a save term according to a carry-save addition.

Multiplication circuitry of this type may be useful, for example, to support at least two data element size configurations for multiplication of one or more respective pairs of data elements selected from the first operand and the second operand, each data element size configuration corresponding to a different combination of data element sizes for the data elements selected from the first operand and the second operand. For example, the data element size configurations can correspond to different SIMD element sizes for a SIMD (single instruction, multiple data) multiplication operation. For example, the first and second operands could be vector operands and each data element could be a respective vector element. In another example, the first and second operands could be matrix operands and each data element could be a respective matrix element. For example, each individual adder sub-array may be sized appropriate for a specific data element size configuration, and selection of which adder sub-arrays are enabled/disabled may depend on the current element size configuration in use. Use of at least two subsets of adder sub-arrays with independent enable/disable control can provide greater energy efficiency for implementing multiplications with different data element size configurations, compared to an implementation which provides a single large adder array (sized according to the maximum data element size) which relies on injecting 0s for some of the partial product bits when performing multiplications with a data element size smaller than the maximum supported size.

However, with this approach, for a signed multiplication operation, there may be greater complexity in implementing sign extensions of the sub-array result values in the result assembly addition. Such sign extension can have a negative impact on both circuit area due to requiring additional adder cells to add sign extension bits, and processing performance due to increased fanout (the extent to which logic gates of the adder array depend on results of earlier logic gates). For circuit designs with increased fan out, it may become challenging to meet targets on circuit timings, which can limit the maximum clock frequency that can be used and hence reduce performance.

In examples discussed below, for a sign-extension-emulated sub-array result value being added in the result assembly addition, the result assembly adder array is configured to perform sign extension emulation by: applying a default zero extension to the sign-extension-emulated sub-array result value regardless of a sign of the sign-extension-emulated sub-array result value, and performing the result assembly addition with at least one other of the plurality of assembled values having a value that, when added in the result assembly addition, emulates an effect of sign extending the sign-extension-emulated sub-array result value up to a bit position corresponding to the most significant bit of the at least one multiplication result value.

Hence, as a zero extension is applied by default to the sign-extension-emulated sub-array result value, this means there is no need to provide specific adder logic gates to add sign extension bits at positions more significant than the most significant bits of the sign-extension-emulated sub-array result value, saving circuit area. An effect of sign extending the sign-extension-emulated sub-array result value is emulated by setting at least one other assembled value being added in the result assembly addition so that an equivalent result is generated to the one that would have been generated if the sign-extension-emulated sub-array result value had been sign extended in the traditional manner by checking the value of a sign bit and injecting bits of equivalent value to the sign bit at all more significant bit lanes of the result assembly addition. The one or more other assembled values which are used to emulate the sign extension may have fewer bits that depend on earlier intermediate results of the multiplication operation, thus reducing fanout. With reduced fanout, the critical path delay through the slowest processing path through the multiplication circuitry can be reduced, and processing performance can be improved. Hence, performing sign extension emulation for the result assembly addition can reduce the circuit area of the multiplication circuitry and improve processing performance.

In some examples, the at least one other of the plurality of assembled values (whose value is set to emulate an effect of sign extension of a given sign-extension-emulated sub-array result value) comprises a static constant having a value selected independent of values of the first operand and the second operand. Use of a static constant helps to reduce fan out and hence improve performance, because the static constant is independent of the values of the first operand and the second operand and so can be hardwired in circuit logic or obtained in parallel with calculation of the sub-array result values, to reduce the critical path delay through the multiplication circuitry.

In some cases, the static constant may depend on the type of multiply operation being performed, so the result assembly adder array may select which static constant to use depending on a parameter defining the multiply operation. Typically information on the operation type may become known at a much earlier timing than the operands, so the constant can still be regarded as relatively static in comparison to intermediate results which depends on the operands themselves.

While the examples above are described in relation to a single sign-extension-emulated sub-array result value, the sign extension emulation may be applied to more than one of the sub-array result values, so in some examples there may be two or more such sign-extension-emulated sub-array result values.

In some examples, the static constant may be shared between a plurality of sign-extension-emulated sub-array result values, the static constant having a value which when added in the result assembly addition provides emulation of sign extension of each of those plurality of sign-extension-emulated sub-array result values. By combining the respective constants which would emulate sign extensions for multiple sign-extension-emulated sub-array result values into a single shared constant, this reduces the number of assembled values to be added in the result assembly addition. Hence, the depth of the result assembly adder array can be reduced and this helps to improve performance and reduce circuit area.

In some examples, the at least one other of the plurality of assembled values also comprises a correction value injected relative to the sign-extension-emulated sub-array result value which, in combination with the static constant, emulates sign extending the sign-extension-emulated sub-array result value, the correction value comprising fewer bits than the static constant. In some cases, the correction value may comprise a single bit correction. The correction value can require fewer additional bits to be injected into the addition for sign extension compared to traditional sign extension methods, reducing circuit area and fanout.

The sign extension emulation may be applied to a number of different types of sign extension which may occur when performing the result assembly addition.

In some examples, the result assembly adder array is configured to perform a first type of sign extension emulation for a given sign-extension-emulated sub-array result value whose most significant bit is of lower significance than a most significant bit of the at least one multiplication result value, and which is generated by one of the adder sub-arrays based on a pair of portions of bits selected from the first operand and the second operand which includes a sign bit of at least one of the first operand or the second operand. Sub-arrays which generate a sub-array result value with a most significant bit equal to the most significant bit of the at least one multiplication result value, and sub-arrays which operate on a pair of portions of bits selected from the first and second operand which do not include a sign bit of at least one of the first operand or the second operand, do not have this first type of sign extension performed. Especially for the adder subarrays requiring the first type of sign extension which generate the sub-array result values of lowest significance, padding the upper end of those sub-array result values with sign extension bits can require a large number of additional bits which greatly increases the circuit area cost and fanout. This can be avoided by performing sign extension emulation for this type of sign extension.

For the first type of sign extension emulation, the result assembly adder array may include in the plurality of assembled values added in the result assembly addition, at least one assembled value providing a same result as applying:
a correction value of +1 at a bit position corresponding to a most significant bit of the given sign-extension-emulated sub-array result value; and
a constant having a value which represents subtraction of 1 at a bit position corresponding to the most significant bit of the given sign-extension-emulated sub-array result value.
   Adding +1 at the most significant bit clears the sign bit of the given sign-extension-emulated sub-array result value to 0, and therefore avoids the need for traditional sign extension bits (set to mirror the top bit of the value being sign-extended), but this would leave the overall addition result at a value which is too large, which can be corrected by also subtracting 1 at the bit position corresponding to the most significant bit. The +1 and −1 corrections can be applied separately using separate assembled values added in the result assembly addition, or could be combined into a single constant applied as a single assembled value in the result assembly addition. In the case of the +1 correction, this could also be applied within the adder sub-array which generates the given sign-extension-emulated sub-array result value, so that the assembled value which provides the same result as the +1 correction can be the given sign-extension-emulated sub-array result value itself (which may already have the +1 correction included at the point it is added by the result assembly adder array). Either way, unlike traditional sign extension bits, these corrections used to emulate the sign extension are static and do not depend on the actual sign bit of the sign-extension-emulated sub-array result value, so can be hardwired or computed in parallel with the sub-array result value. Compared to deriving sign extension bits once the sign bit becomes known, this helps to reduce the length and inter-connectedness of dependent chains of logic gates (fanout) and hence improve performance.

In some implementations of the multiplication circuitry, each adder sub-array generates, as the one or more sub-array result values, a sum term and a carry term which when added together would give the result of the signed multiplication of the respective pairs of portions, and the result assembly adder array includes, as separate assembled values in the plurality of assembled values being added in the result assembly addition, the sum term and the carry term for a given adder sub-array. By adding the sum and carry terms as separate assembled values in the result assembly addition, this avoids any need for a carry propagate adder to add the sum and carry terms together to produce a non-redundant representation of the output of a given adder sub-array before the result assembly addition is performed. This helps improve performance because a carry propagate adder can be very slow in comparison to carry save additions which produce sum and carry terms.

However, for such an implementation which includes the sum term and carry term as separate assembled values to be added in the result assembly addition, there is a second cause of sign extension. This arises because, if the sum term and the carry term had been added by a carry propagate adder prior to the result assembly addition, this carry propagate addition would generate a carry out bit which if set to 1 would indicate that the product generated by a given adder sub-array was negative. While this carry is not actually generated as the carry propagate addition is not being performed, it should be accounted for and if the carry would be 1 then it would require sign extension to ensure that the sign of the product generated by the given adder sub-array is preserved during the result assembly addition. If handled using the traditional method of sign extension, this would again require a relatively large number of additional adder cells, as well as increasing fanout due to injecting a large number of sign extension bits which depend on the carry out bit from the sum/carry addition, which will then cause all subsequent levels of an adder reduction tree to also depend on that carry out bit.

In contrast, in some examples discussed below, the result assembly adder array may perform a second type of sign extension emulation to emulate a sign extension of a carry out which would be caused by addition of the sum term and the carry term from the given adder sub-array (if such an addition was actually performed—as noted above, it does not need to be performed). By using the sign extension emulation technique described above for the second type of sign extension, this again can save circuit area and improve performance by reducing the number of sign extension bits that need to be applied which are dependent on the specific values output from the given adder sub-array.

For the second type of sign extension emulation applied to the sum term and the carry term from the given adder sub-array, the result assembly adder array may include in the plurality of assembled values added in the result assembly addition:
a correction value at a bit position one place higher than a most significant bit of the sum term, the correction value having opposite bit value to the carry out caused by addition of the sum term and the carry term; and
a static constant having a value which represents subtraction of 1 at a bit position one place higher than the most significant bit of the carry term.
   The combination of such a correction value and constant helps emulate the combined effect of injecting the carry out bit itself and emulating the carry out bit's sign extension.

For the second type of sign extension emulation, the result assembly adder array may select whether the correction value is 0 or 1 based on carry out bits obtained by the given adder sub-array when generating the sum term and the carry term. This can help improve performance because the correction value can be obtained by the given adder sub-array rather than needing a subsequent carry propagate adder to actually add the sum and carry terms.

Another type of sign extension may arise in implementations where the multiplication circuitry supports a negated signed multiplication operation in which the at least one multiplication result value represents −1 times a result of signed multiplication of the first operand and the second operand. In this case, if the negated signed multiplication operation is performed, sub-array result values whose most significant bit is of lower significance than a most significant bit of the at least one multiplication result value may require sign extending even if they are generated based on portions of the first operand and second operand which do not include either operand's most significant bit (unlike for standard non-negated multiplications where such sub-array result values would not need sign extension because result values which do not depend on the sign bits of the operands are treated as positively weighted in a signed value using two's complement notation). The sign extension emulation technique described above can also be used to eliminate costly sign extension bits for such a third type of sign extension.

Hence, for the negated signed multiplication operation, the result assembly adder array may perform a third type of sign extension emulation for a given sign-extension-emulated sub-array result value whose most significant bit is of lower significance than a most significant bit of the at least one multiplication result value, and which is generated by one of the adder sub-arrays based on a given pair of portions of bits selected from the first operand and the second operand where neither of the given pair of portions of bits selected from the first operand and the second operand includes a sign bit. As by definition the third type of sign extension emulation affects the adder sub-arrays which generate results of relatively low significance compared to the most significant bit of the overall multiplication result, this third type of sign extension would normally require a relatively large number of sign extension bits to be applied to sign extend the sub-array result value up to the most significant bits of the at least one multiplication result value. This would be relatively costly and this cost can be avoided by performing the third type of sign extension emulation.

For the third type of sign extension emulation, the result assembly adder array may include in the plurality of assembled values added in the result assembly addition:
a static constant having a value which represents adding 1s at all bit positions more significant than a most significant bit of the given sign-extension-emulated sub-array result value; and
a correction value at a bit position one place higher than a most significant bit of the given sign-extension-emulated sub-array result value, the correction value being 1 if one or both of the given pair of portions of bits selected from the first operand and the second operand is zero, and being 0 if one of the given pair of portions of bits selected from the first operand and the second operand is non-zero.
   As whether the given pair of portions of bits of the first operand or the second operand are zero can be either known in advance, or computed relatively quickly compared to the main processing path through the multiplier circuitry, the correction value can be determined in advance or in parallel with calculation of the given sign-extension-emulated sub-array result value, so can be taken off the critical timing path. Hence, both the static constant and the correction value for the third type of sign extension emulation need not depend on the output of the sub-array generating the given sign-extension-emulated sub-array result value. Therefore, use of the third type of sign extension emulation can improve performance.

It is not essential for all of the first, second and third types of sign extension emulation to be implemented. A given circuit implementation of the multiplication circuitry may implement any one or more of these types of sign extension emulation. Where more than one type of sign extension emulation is implemented, the constants for providing each type of sign extension emulation can be combined into a single shared constant whose value reflects the combined effects of each of the individual types of sign extension emulation.

Another type of operation which may involve costly sign extension may be a signed multiply-add operation for which first and second signed operands are multiplied and the result of the multiplication is added to a third signed operand. Typically, a multiplier for performing a stand-alone multiplication operation may handle sign extensions of the partial products generated from the first and second signed operands relatively efficiently, but when a further addition of the third signed operand is required, that third signed operand may be included as an additional value to be added in the partial product adder array, and typically its sign extension is handled in the traditional manner with bits equal in value to the most significant bit of the third signed operand being injected at every bit position more significant than the most significant bit of the third signed operand, up to the most significant bit of the overall multiplication result. This sign extension can be relatively costly for circuit area and performance.

In contrast, in some examples of multiplication circuitry described below, where an adder array adds a number of partial products (selected by partial product selection circuitry based on the first signed operand and the second signed operand) to a third signed operand, the adder array may apply a default zero extension to the third signed operand regardless of a sign of the third signed operand, and the partial product selection circuitry may adjust one of the partial products added by the adder array to emulate an effect of sign extending the third signed operand. Similar to the examples above, this conserves circuit area and reduces fanout therefore improving performance for signed multiply-add operations.

In some examples, each partial product added by the adder array has a sign extension header to emulate sign extension based on a sign of the corresponding partial product. The partial product selection circuitry may adjust the sign extension header associated with a least significant partial product based on the sign of the third signed operand, to emulate the effect of sign extending the third signed operand. In particular, the partial product selection circuitry may set the sign extension header associated with the least significant partial product to have a value which is 1 lower when the third signed operand is negative than when the third signed operand is positive. This eliminates any need for a series of sign extension bits to be applied at the upper end of the third signed operand, hence reducing circuit area and improving performance as mentioned above.

An apparatus may comprise processing circuitry to perform data processing in response to instructions; and the processing circuitry may comprise any of the examples of multiplication circuitry described above. For example, the processing circuitry could be a CPU (Central Processing Unit), GPU (Graphics processing unit) or other processing unit within a data processing system (e.g. a Neural Processing Unit provided for performing neural network processing or other machine learning operations).

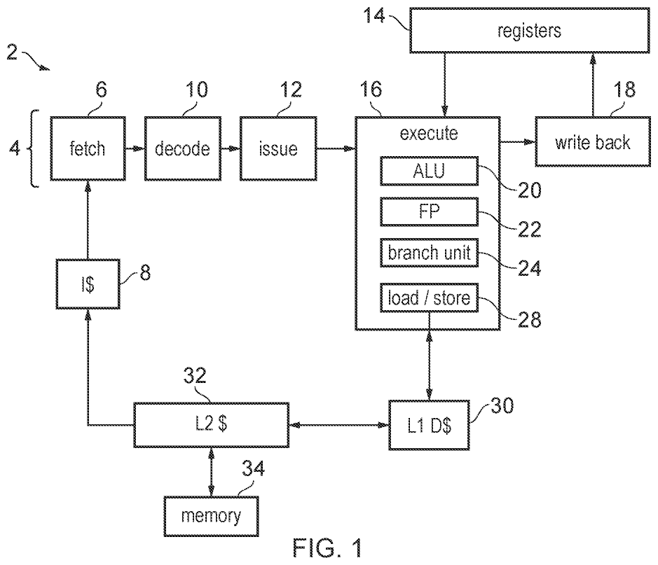

FIG. 1 schematically illustrates an example of a data processing apparatus 2. The data processing apparatus has a processing pipeline 4 (an example of processing circuitry) which includes a number of pipeline stages. In this example, the pipeline stages include a fetch stage 6 for fetching instructions from an instruction cache 8; a decode stage 10 for decoding the fetch program instructions to generate micro-operations to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor an additional register renaming stage could be included for mapping architectural registers specified by program instructions or micro-operations to physical register specifiers identifying physical registers in the register file 14.

The execute stage 16 includes a number of processing units, for executing different classes of processing operation. For example the execution units may include an integer or fixed-point arithmetic/logic unit (ALU) 20 for performing arithmetic or logical operations on scalar operands or vector operands read from the register file 14; a floating point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system include a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

One example of an operation which may be supported by the processing circuitry 4 (e.g. within the ALU 20 or the floating point unit 22) is a multiplication operation. In some systems, a dedicated execution unit called a multiply-accumulate (MAC) unit may be provided to handle multiplications since multiply-accumulate operations (where two operands are multiplied and the result is added to an accumulator value). A multiply-accumulate (also known as multiply-add) operation may be frequently used in digital signal processing algorithms for example, so any techniques for improving energy efficiency and reducing pressure to meet circuit timings can be extremely helpful.

While some examples below discuss a multiplication operation for conciseness, this is intended to encompass multiply-add or multiply-accumulate operations, so even if a subsequent adder for adding the multiplication result to a third operand is not shown, such a subsequent adder could still be provided. It is also possible to provide standalone multiplication operations which produce a multiplication result without also adding the multiplication result to a third operand.

The multiplication circuitry 40, 50 described below uses a technique known as Booth multiplication, which is based on the principle that, when multiplying a first value (a multiplicand M) by a second value (a multiplier R) to obtain a multiplication result M*R, within the multiplicand M a string of consecutive binary 1s can effectively be replaced with a +1 at the bit position one place higher than the upper end of the string and a −1 at the bit position corresponding to the lower end of the string, which can help to reduce many of the partial products to zero and so make processor logic implementation more straightforward. This is analogous to 999 in decimal being equivalent to 1000−1. Hence, if considering a multiplication of 999*R, the “schoolbook” long multiplication approach would carry out a series of additions of partial products 900*R+90*R+9*R. With the Booth approach this could be reduced to 1000*R−1*R. Respective overlapping groups of bits (referred to as “Booth digits” below) of the multiplicand M can be analysed to look for patterns representing the start/end of runs of successive 1s, and this can be used to deduce each multiple of R to be selected as a respective partial product to be added to form the product result. Although Booth multiplication is described here, the sign extension emulation techniques described below could also be applied to the adders which add partial products in a multiplier which does not use Booth multiplication, e.g. one where the partial products are defined according to the traditional “schoolbook” multiplication approach shown for comparison below.

Booth multiplication involves three stages:

### 1. Booth Encoding the Multiplicand M.

The multiplicand M is logically partitioned into a series of overlapping Booth digits each corresponding to a subset of bits of the multiplicand M. For each Booth digit, the Booth encoder analyses the pattern of bits in that Booth digit and outputs, as a Booth encoding of that Booth digit, a partial product selection indicator which indicates which of a number of different multiples of the multiplier R should be selected as a corresponding partial product to be included in the set of partial products added to produce the multiplication result M*R. Different “radix” versions of the Booth encoding scheme can be provided, where the radix indicates how many bits of the multiplicand M are considered in each Booth digit. Neighbouring Booth digits overlap by 1 bit. The least significant Booth digit is padded with a fixed bit of 0b0 at the lower end. The most significant Booth digit is padded with at least one bit above the most significant bit of M. The padding bits correspond to a sign-extension of the multiplicand.

For example, for a Radix-4 Booth multiplication, each Booth digit comprises 3 bits, and neighbouring Booth digits overlap by 1 bit. For example, for an 8-bit multiplicand M having bits M[7:0], the Booth digits may comprise:
M[1:0]:0b0 (the lower two bits of M concatenated with a fixed value of 0 at the lower end).
M[3:1]
M[5:3]
M[7:5]
3 bits comprising a sign extension of M[7] (e.g. for unsigned values this would be 0b00: M[7] and for signed values represented in two's complement representation all three bits are set equal to M[7]).

The Booth encoder implements hardware circuit logic that, based on the pattern of bits in a given Booth digit, determines which multiple of the multiplier R should be selected for a corresponding partial product. The rules for which multiple to select for a given pattern of bits in a Booth digit are based on whether a run of successive 1s starts or ends within that Booth digit. For example, if all bits are 0 or all bits are 1 within the Booth digit, the multiple to select is 0*R because there is no run of 1s starting or ending within the Booth digit. For Booth digits involving a mix of 0s and 1s, the multiple to select depends on the position where any transition from 0 to 1 or 1 to 0 occurs, so that the multiple implements the combined effect of (i) adding a +R multiple at a bit position one higher than the top bit of any run of successive 1s occurring within the Booth digit and (ii) adding a −R multiple at a bit position corresponding to the bottom bit of any run of successive 1s occurring within the Booth digit. However, as the Booth digits are assessed multiple bits at a time, for Radix-4 or higher-radix Booth encoding, higher multiples of R such as ±2*R are considered to account for the fact that the +R or −R multiple could be injected at different bit positions within the Booth digit. Some worked examples are discussed below for Radix-4 and Radix-8, but it will be appreciated that other radix values could be used. For each Booth digit of the multiplicand M, the Booth encoder outputs a partial product selection indicator indicating which of a set of candidate multiples of the multiplier R should be selected for a corresponding partial product.

### 2. Selection of Partial Products

The required multiples of the multiplier R are prepared (this can be done in parallel with the Booth encoding). For example, for Radix-4 operations, the multiples of R that could be selected for a given Booth digit are: +2*R, +R, 0, −R, −2*R. For Radix-8 the multiples extend from +4*R to −4*R. Hence, partial product selection circuitry may form the multiple values. Forming the multiple values may include negation of R for forming the negative multiples, left shifting of R to form power-of-2 multiples such as ±2*R and ±4*R, and, if the radix is such that a non-power of 2 multiple such as ±3*R is required, addition of other multiples (e.g. adding ±2*R and ±R to form the ±3*R multiple).

From among the candidate multiples, for a given Booth digit partial product selection circuitry selects one of the multiples, based on the partial product selection indicator provided by the Booth encoder for that given Booth digit.

### 3. Addition of Partial Products

The partial products selected for each Booth digit are added together (with an appropriate alignment between the partial products for adjacent Booth digits to account for the relative magnitude of the partial product based on the position where the Booth digit was found within the multiplicand M).

To illustrate Booth multiplication, consider a multiplication M*R where M and R are both 8-bit values and the decimal values corresponding to M and R are M=56 and R=47:
M=00111000
R=00101111

With a traditional “schoolbook” long multiplication method, this can be converted into a series of partial products as follows (where PPi is +R if the corresponding bit i of M is 1 and is 0 if the corresponding bit i of M is 0):
Add partial products (shifted by 1 each time):

$$\frac{\begin{matrix}{P}_{0} & 00000000 \\ {P}_{1} & 00000000 \\ {P}_{2} & 00000000 \\ {P}_{3} & 00101111 \\ {P}_{4} & 00101111 \\ {P}_{5} & 00101111 \\ {P}_{6} & 00000000 \\ {P}_{7} & 00000000 +\end{matrix}}{\begin{matrix}0000101001001000 \\ = {2632}_{10} = 56 * 47\end{matrix}}$$

9 partial products for 8*8 bit multiplication

With the schoolbook approach, the run of successive 1s in M causes three partial products PP3, PP4, PP5 to include +R multiples. With the Booth approach, the same result could have been achieved by adding +R for PP6 and adding −R for PP3, but with Radix-2 (which would correspond to Booth digits each comprising 2 bits), this would not enable the number of partial products to be reduced. Hence, most practical Booth implementations use Radix-4 or higher.

For Radix-4, the Booth digits are selected based on the bits of M as explained earlier, and the encoding rules are as follows:

| Selected Booth | Multiple of R selected |
|---|---|
| digit Mᵢ₊₁, Mᵢ, Mᵢ₋₁ | as Partial Product |
| 000 | 0 |
| 001 | +1 |
| 010 | +1 |
| 011 | +2 |
| 100 | −2 |
| 101 | −1 |
| 110 | −1 |
| 111 | 0 |

Using the same example of M=56 and R=47, the multiple values available for selection for each partial product are:
+2R=01011110
+R 00101111
0=00000000
−R=11010001
−2R=10100010
   and the multiplicand is:
M=00111000

Hence, the Booth digits selected from the multiplicand M, and the corresponding partial products selected for each Booth digit according to the encoding rules shown above are as follows:

$${BD}_{0} = {M}_{1} , {M}_{0} , {M}_{- 1} = 00 ( 0 ) -> {PP}_{0} = 0 \\ {BD}_{1} = {M}_{3} , {M}_{2} , {M}_{1} = 100 -> {PP}_{1} = - 2 R = 10100010 \\ {BD}_{2} = {M}_{5} , {M}_{4} , {M}_{3} = 111 -> {PP}_{2} = 0 \\ {BD}_{3} = {M}_{7} , {M}_{6} , {M}_{5} = 001 -> {PP}_{3} + R = 00101111 \\ {BD}_{4} = SE , SE , {M}_{7} = 000 -> {PP}_{4} = 0$$

Adding partial products (shifted by 2 each time to account for relative alignment of each Booth digit) gives:

$$\frac{\begin{matrix}{PP}_{0} & 00000000 \\ {PP}_{1} & 11111110100010 ( {PP}_{1} sign extended ) \\ {PP}_{2} & 00000000 \\ {PP}_{3} & 00101111 \\ {PP}_{4} & 0000000000 +\end{matrix}}{\begin{matrix}0000101001001000 \\ = {2632}_{10} = 56 * 47\end{matrix}}$$

Hence, the same numeric result can now be achieved while adding only 5 partial products, rather than 9.

Similarly, for Radix-8, the Booth encoding rules are as follows:

| Selected Booth | Multiple of R selected |
|---|---|
| digit Mᵢ₊₂:Mᵢ₋₁ | as Partial product |
| 0000 | 0 |
| 0001 | +1 |
| 0010 | +1 |
| 0011 | +2 |
| 0100 | +2 |
| 0101 | +3 |
| 0110 | +3 |
| 0111 | +4 |
| 1000 | −4 |
| 1001 | −3 |
| 1010 | −3 |
| 1011 | −2 |
| 1100 | −2 |
| 1101 | −1 |
| 1110 | −1 |
| 1111 | 0 |

Applying this to the same M=56 and R=47 example gives:
M=00111000
+4R=10111100
+3R=01110011
+2R 01011110
+R=00101111
0=00000000
−R=11010001
−2R=10100010
−3R=(1) 01110011
−4R=(1) 01000100
BD₀=M₂:M₋₁=000(0)->PP₀=0
BD₁=M₅:M₂=1110->PP₁=−R=11010001
BD₂=M₈:M₅=(0)001 (bit 8 sign extended from bit 7)->PP₂=+R=00101111
Add partial products (shift by 3 each time):

$$\frac{\begin{matrix}{PP}_{0} & 00000000 \\ {PP}_{1} & 11111010001 ( {PP}_{1} sign extended ) \\ {PP}_{2} & 00101111 +\end{matrix}}{\begin{matrix}00101001001000 \\ = {2632}_{10} = 56 * 47\end{matrix}}$$

Now the result can be achieved in 3 partial products.

Hence, an approach using a higher radix can treat the multiplicand M as including fewer Booth digits and hence require fewer partial products to be added, but this is at the expense of increased complexity in having more options for the multiple selection (which will increase the circuit complexity of generating the multiple values and the multiplexers which select the multiple, as well as the complexity of the Booth encoder).

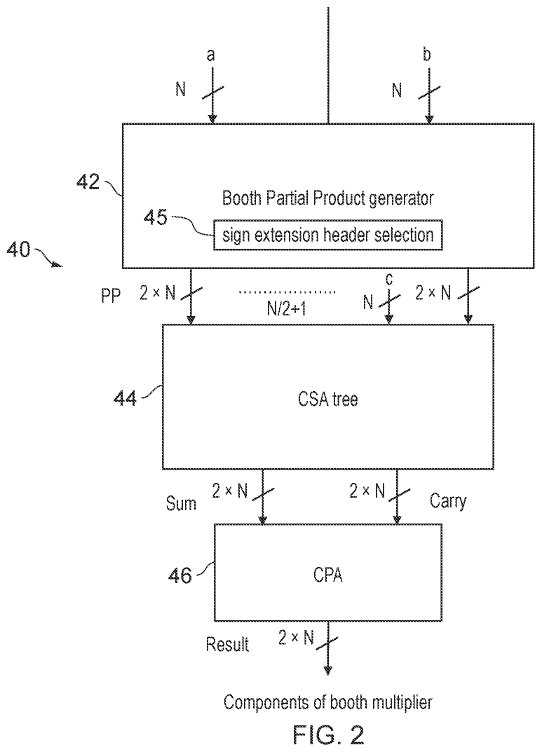

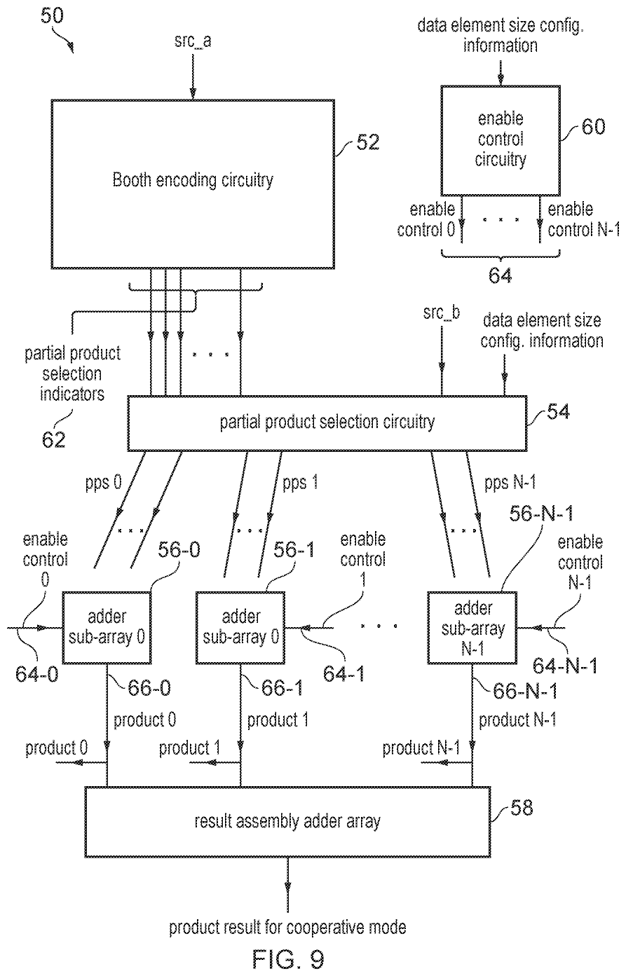

FIGS. 2 and 9 illustrate examples 40, 50 of multiplication circuitry which can be included within the execute stage 16 of the processor 2 (either within the ALU 20, or within the floating point unit 22, or in another execution unit such as a vector ALU or matrix processing unit separate from an ALU used for scalar operations). The examples below show that the multiplication operation is performed on data elements having a number of bits equal to a power of 2, which may be common if the operations are performed on integer operands. However, it is not essential for the data elements to have a number of bits corresponding to a power of 2. For example, for multiplications performed on the significands of floating-point operands, the significands may have a non-power-of-2 number of bits because some of the bits of a power-of-2 sized floating-point representation are used for the sign and exponent. Hence, it will be appreciated that the examples below could be adjusted for handling other data element sizes. Also, while the examples below assume the pair of portions of the two operands being multiplied together are of equal number of bits (e.g. a 16-bit*16-bit multiplication, or a 32-bit*32-bit multiplication), this is not essential and it is also possible to provide data element size configurations with asymmetric sized portions being multiplied (e.g. a 16-bit*8-bit multiplication). For example, multiplication circuits with asymmetric operand sizes may be useful for machine learning processing, where for example the kernel weights for a neural network may have fewer bits than the activations being multiplied by the kernel weights.

In the example of FIG. 2, the multiplication circuitry comprises partial product selection circuitry 42 (also referred to below as a partial product generator), an adder array 44 and carry propagate adder 46. The partial product selection circuitry 42 Booth encodes a first signed operand “a” (also referenced below as opa) and selects, as partial products for the multiplication, multiples of a second signed operand “b” (also referenced below as opb). Each partial product is selected based on a corresponding Booth digit obtained by Booth encoding the first signed operand opa.

The Booth digit encoding and partial product selection are performed according to the Booth multiplication technique discussed above. The Booth partial product generator 42 could operate according to any radix (e.g. radix 4 or radix 8) and may be implemented according to any known Booth encoding/partial product selection technique. Nominally, for N bit operands, there are N/2+1 Booth digits and hence N/2+1 partial products. However, for a signed multiplication of 32-bit operands with Radix-4 Booth encoding, the 17th Booth digit is not needed as it may always correspond to either 000 or 111 and so correspond to a multiple of 0*opb, so does not require explicit addition (the (N/2+1) th Booth digit may be used for unsigned multiplications which do not require the sign extension techniques described here).

The adder array 44 is a carry-save adder tree which performs several stages of 3:2 carry-save additions to reduce the partial products to a sum term and a carry term. The carry propagate adder 46 adds the sum and carry terms to produce a single result value in a non-redundant representation.

For a signed multiplication of the first operand opa and the second operand opb, the addition performed by the carry-save adder tree takes account of the sign of each partial product, which may depend not only on whether the Booth digit generated by encoding the first operand opa causes a positive or negative multiple to be selected as the partial product, but also on the sign of the second operand opb whose multiples are selected for the partial products.

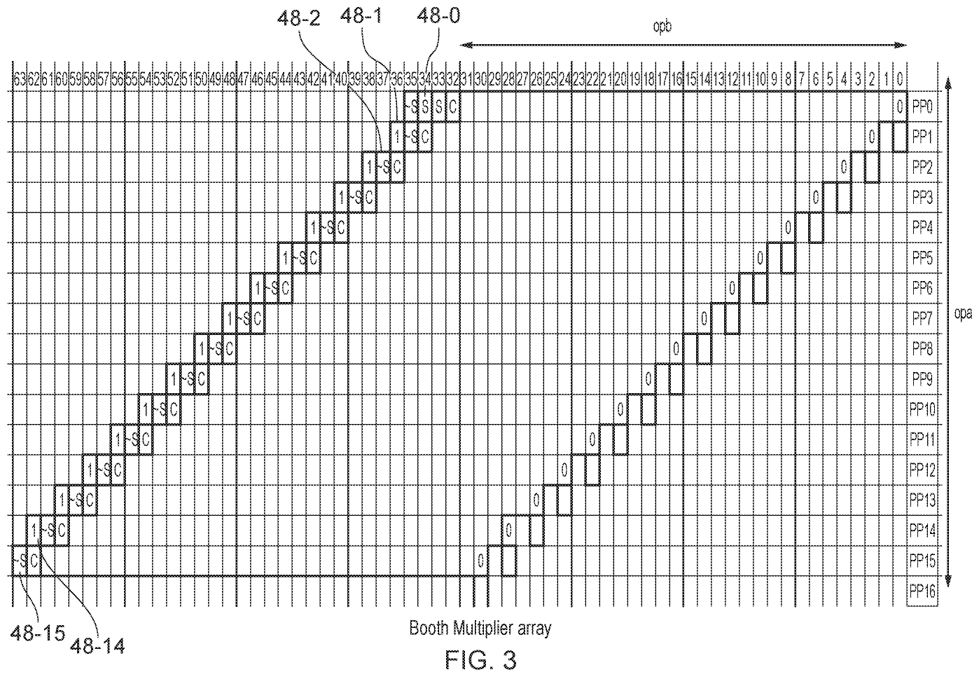

On the face of it, this would therefore require some sign extension bits to be added at all bit positions more significant than the most significant bit of each partial product, for example:
PP₀ aaaaaaaA . . .
PP₁ bbbbbB . . .
PP₂ cccC . . .
PP₃ dD . . .
. . .
   where A, B, C, D are the most significant bits of partial products PP0, PP1, PP2, PP3 respectively (corresponding to a sign bit), and a, b, c, d are sign extension bits of same value as A, B, C and D respectively. While this simplified example does not require many sign extension bits, for larger operand sizes such as that shown in the example of FIG. 3 (with 32-bit operands opa and opb), performing full sign extension can be relatively costly because they impact the area, power and timing for the multiplication circuitry.

The combined effect of all the sign extensions can instead be implemented by providing each partial product with a sign extension header 48 which is injected at a few additional bit positions more significant than the upper bit C of each partial product. The sign extension headers 48 for the partial products are selected by the partial product generator 42 in parallel with selection of the significant bits A, B, C, D etc. for the partial products. As shown in FIG. 3, the sign extension header 48-0 for the least significant partial product PP0 is ˜S, S, S, C, the sign extension header 48-15 for the most significant partial product PP15 is ˜S, C and the sign extension header 48-1 to 48-14 for all intervening partial products is 1, ˜S, C, where C is the top non-sign bit of the relevant partial product, S is the sign bit of the relevant partial product and ˜S has the opposite value to S. The boxes in rows PP1, PP2 . . . . PP15 surrounded in bold outline represent carry bits, where the carry from PP0 is shown alongside PP1, and so on for the other partial products.

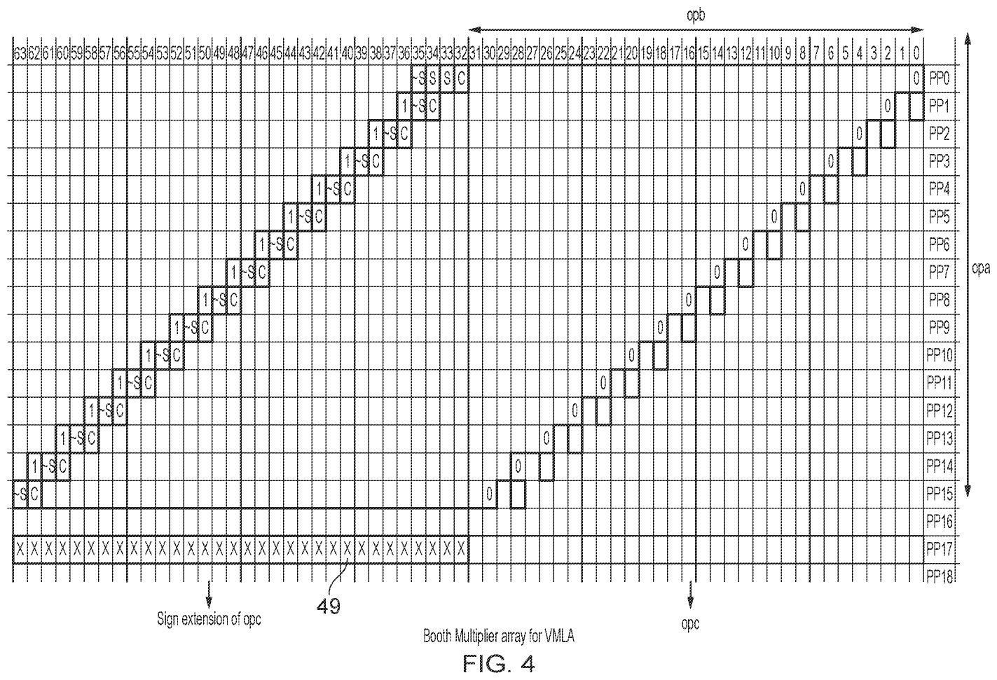

If a signed multiply-add operation (MAC or MLA) is performed to compute C+A×B, this can be achieved by simply passing operand C (opc) to the adder array 44 as another partial product, as shown in FIG. 4. However, as opc is typically aligned to the least significant partial product, this means for a signed multiply-add, opc may require a long string of sign extension bits X which require additional adder cells in the adder array 44, and which increase the critical path delay.

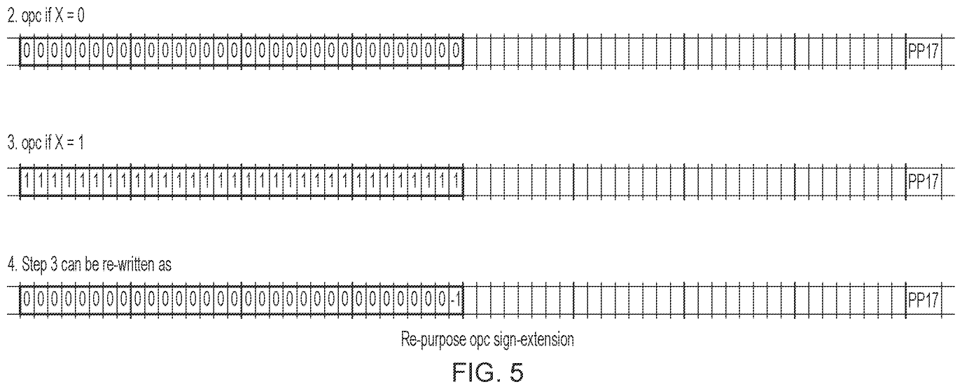

FIG. 5 illustrates repurposing the opc sign extension. The sign extension bits X for opc are either equal to 0 (if opc is positive) or equal to 1 (if opc is negative). If opc is positive, the sign extension does not require any explicit adder cells to add any bit values to the results computed in the preceding rows of the adder array based on the partial products derived from opa, opb. If opc is negative, then adding 1s at all sign extension bit positions more significant than the most significant bit of opc is equivalent to subtracting 1 at the bit position one place more significant than the most significant bit of opc.

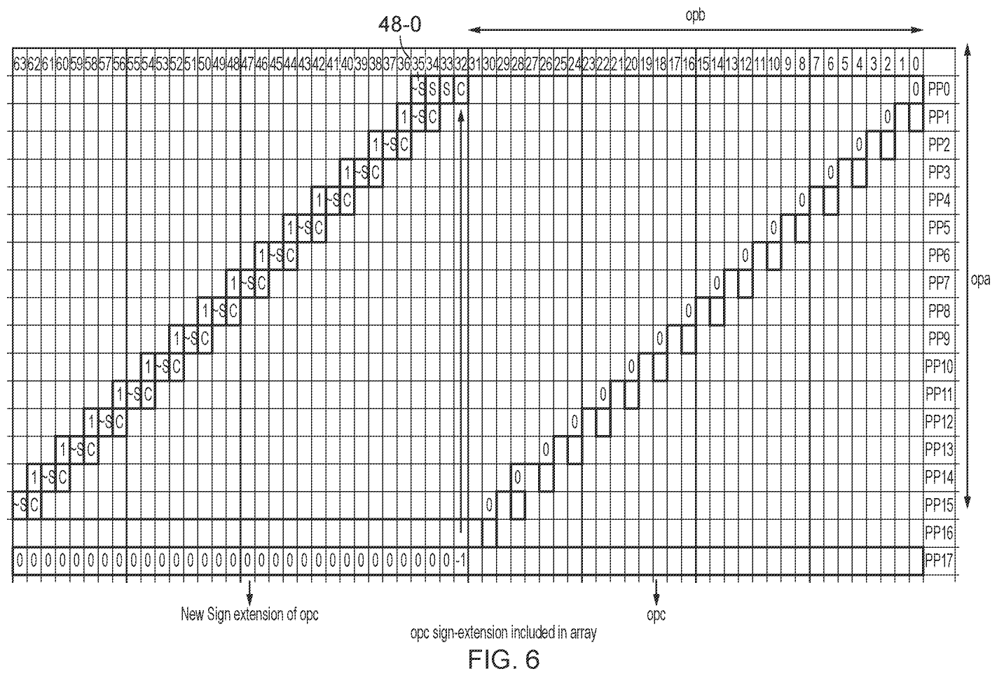

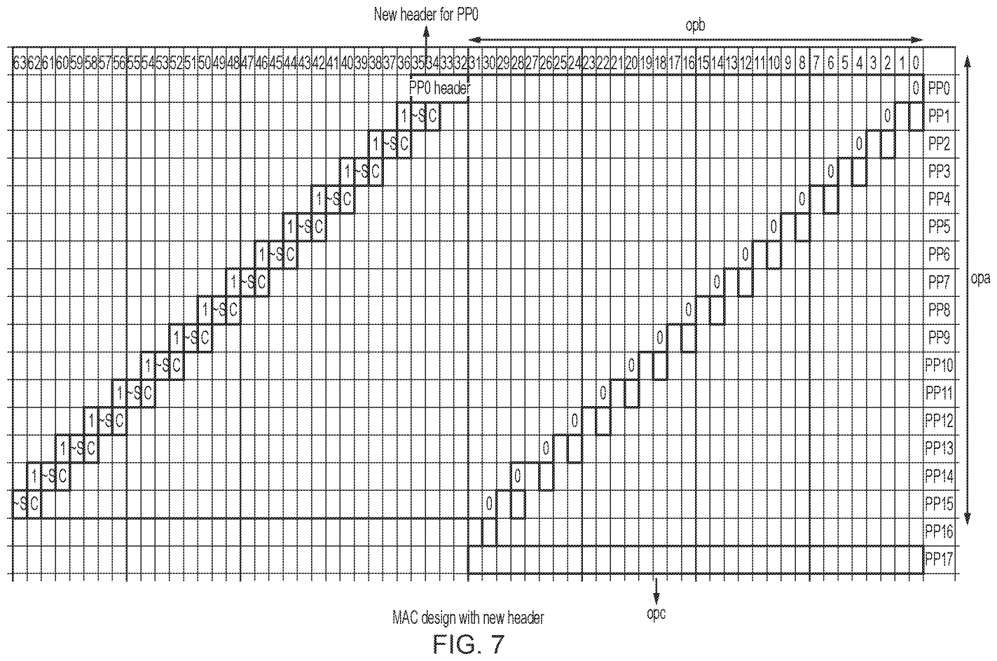

As shown in FIG. 6, this subtraction of 1 would be aligned to the least significant bit of the sign extension header 48-0 for the least significant partial product PP0. Therefore, as shown in FIG. 7, a new sign extension header 48-0 can be calculated for PP0 which accounts for both the sign extension of PP0 and emulation of the sign extension required for opc. If opc is positive, the sign extension bits are 0 and so the sign extension header for PP0 is the same as if performing a signed multiplication operation without a subsequent accumulation with opc. Hence, the sign extension header for PP0 would still be ˜S, S, S, C as described above. However, if opc is negative, then an adjustment is made to the sign extension header 48-0 for the least significant partial product PP0, to reduce the sign extension header 48-0 by 1 compared to the case where opc is positive and introduce the effect of subtracting 1 as shown in part 4 of FIG. 5.

Hence, as shown in FIG. 2, the partial product generator 42 may include sign extension header selection circuitry 45. When a signed multiply-add operation is performed using the multiplication circuitry 40, the sign extension header selection circuitry 45 selects the sign extension header for the least significant partial product PP0 based on the sign bit and next most significant bit of PP0 as well as based on the sign bit of opc, as follows:

| S | C (top non-sign | sign bit | sign extension |
|---|---|---|---|
| (sign of PP0) | bit of PP0) | of opc | header for PP0 |
| 0 | 0 | 0 | 1000 (8 decimal) |
| 0 | 1 | 0 | 1001 (9 decimal) |
| 1 | 0 | 0 | 0110 (6 decimal) |
| 1 | 1 | 0 | 0111 (7 decimal) |
| 0 | 0 | 1 | 0111 (7 decimal) |
| 0 | 1 | 1 | 1000 (8 decimal) |
| 1 | 0 | 1 | 0101 (5 decimal) |
| 1 | 1 | 1 | 0110 (6 decimal) |

The top four rows of the table show the case when opc is positive and so the sign extension header 48-0 for PP0 is computed according to ˜S, S, S, C as described above. The lower four rows show the case when opc is negative and so the sign extension header is 1 lower than when opc is positive to reflect subtraction of 1. With this change, it can be seen that the only new output value for PP0's sign extension header 48-0 is “0101” (5 in decimal), so this change would be relatively low cost to implement in hardware.

Hence, by adjusting the sign extension header 48-0 associated with the least significant partial product PP0 based on the sign of the third signed operand opc, this can emulate the effect of sign extending the third signed operand, making it unnecessary to apply sign extension to the third signed operand opc. Instead, a default zero extension can be applied to opc regardless of the actual sign of opc. This avoids the added cost of adding the sign extension bits X shown in FIG. 4.

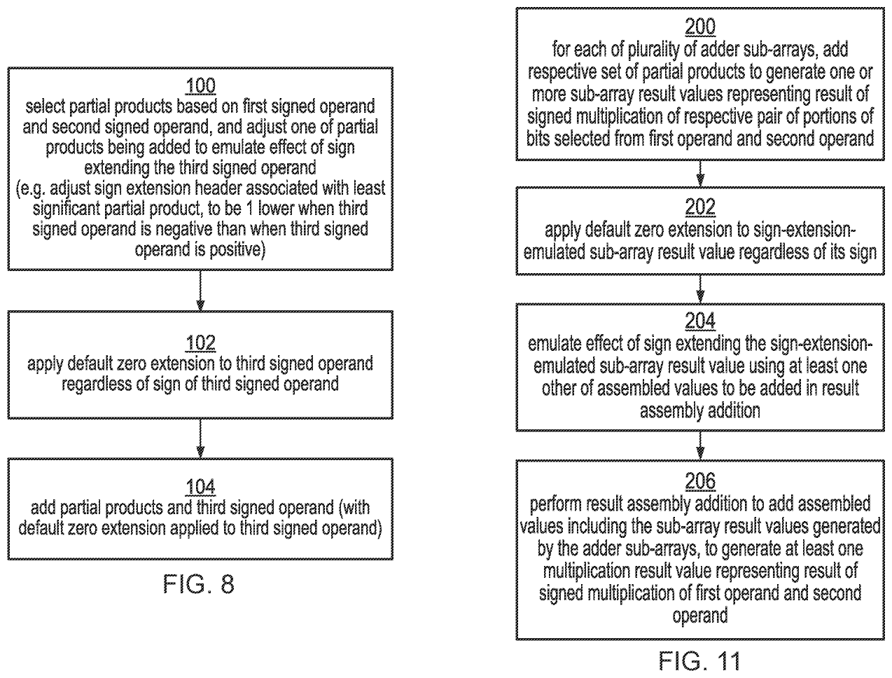

FIG. 8 is a flow diagram illustrating a method of performing a signed multiply-add operation. At step 100, partial products are selected based on a first signed operand opa and a second signed operand opb. The partial products may be selected as multiples of opb selected based on Booth digits obtained by Booth encoding the first operand opa. One of the partial products to be added by the adder array 44 is adjusted to emulate an effect of sign extending the third signed operand. More particularly, the sign extension header associated with the least significant partial product PP0 is adjusted to be one lower when the third signed operand opc is negative than when opc is positive.

At step 102, a default zero extension is applied to the third signed operand opc regardless of its sign.

At step 104, the adder array 44 adds the partial products selected at step 100 (including the least significant partial product with its adjusted sign extension header) and the third signed operand (with the default zero extension applied). The adder array 44 may be a 3:2 carry save adder tree which produces its result in a redundant form comprising a sum term and a carry term. A carry propagate adder 46 may then add the sum and carry terms to produce a non-redundant result in two's complement form, representing C+A*B, where C is the third signed operand, A is the first signed operand and B is the second signed operand.

FIG. 9 illustrates another example of multiplication circuitry 50 which can be included within the execute stage 16 of the processor 2. This example implements a subarray multiplier whose largest data type is collaboratively computed by a number of smaller multipliers. The subarrays are natively sized to the smaller supported data types and have separate enable/disable control signals so that when the smaller data types are computed, unused sub-arrays can be disabled to save power.

As shown in FIG. 9, the multiplication circuitry 50 includes Booth encoding circuitry 52, partial product selection circuitry 54, a set of adder sub-arrays 56, a result assembly adder array 58 and enable control circuitry 60. The multiplication circuitry 50 receives a first operand src_a, a second operand src_b, and data element size configuration information indicating a data element size configuration to be used for processing the first and second operands src_a, src_b. The first and second operands may be SIMD (single-instruction-multiple-data) operands having a number of independent data elements each representing a separate data value within the same operand. For example, the first and second operands may be vector operands representing a one-dimensional array of independent vector elements, or matrix operands representing a two-dimensional array of independent matrix elements. The first and second operands may be obtained from source registers specified by a multiplication instruction executed by the processing circuitry and/or may be forwarded from a result generated by an earlier instruction in the processing pipeline 4.

For one of the data element size configurations, the first and second operands may be treated as single data elements to be multiplied together, but for other data element size configurations each of the first and second operands may be logically divided into multiple independent data elements and the product result to be generated may be a vector or matrix comprising a number of result data elements each corresponding to the product of a corresponding pair of data elements of the first and second operands. For a given multiply operation, the data element size configuration information may depend on an immediate operand or register operand of an instruction executed by the processing circuitry 4, and/or based on element size mode information stored within the system register of the processing circuitry 4. The data element size configuration information may vary from one multiplication operation to another.

The Booth encoding circuitry 52 Booth encodes the first operand src_a, to generate a set of partial product selection indicators 62 which each correspond to a Booth encoding of a respective Booth digit of the first operand. The Booth encoding is generated based on the bit patterns of the corresponding Booth digit, according to the encoding rules shown for radix-4 or radix-8 above (or alternatively, if higher radix is used for the Booth encoding, according to similar rules for that higher radix).

The partial product selection circuitry 54 selects, based on the second operand src_b and the partial product selection indicators 62, the sets of partial products to be added by each of the adder sub-arrays 56. For example, a first set of partial products “pps 0” is selected for adder array 56-0, a second set of partial products “pps 1” is selected for adder array 56-1, and so on. The partial product selection may also depend on the data element size configuration information (e.g. different portions of the second operand src_b may be used to select the partial products, depending on whether the data element size configuration information indicates use of a cooperative mode where the adder sub-arrays operate cooperatively to compute the largest data type or a non-cooperative mode where one or more adder sub-arrays work independently to compute SIMD product results for smaller data types). For each partial product, the partial product is a selected multiple of a corresponding portion of the second operand src_b, where that multiple can range from +2*R to −2*R for radix-4 and from +4*R to −4*R for radix-8 (where R is the value corresponding to the selected portion of bits of the second operand src_b that is relevant for a given adder sub-array 56). Different adder sub-arrays 56 may have their partial products selected based on different portions of the second operand src_b. As well as selecting the partial products, the partial product selection circuitry 54 may also include circuitry for generating the multiple values available for selection as the partial products—e.g. including shifting circuitry, negation circuitry, and/or adding circuitry to generate the required +2*R to −2*R or +4*R to −4*R multiples for each portion of the second operand src_b. The circuitry for generating the multiple values based on src_b may operate in parallel with the Booth encoding circuitry 52 generating the partial product selection indicators 62 based on the first operand src_a.

Each adder sub-array 56 receives its set of partial products, and when enabled based on a corresponding enable control signal 64 provided by the enable control circuitry 60, adds its partial products to generate at least one corresponding sub-array result value 66 which represents a result of multiplication of a respective pair of portions of bits selected from the first operand src_a and the second operand src_b. The one or more sub-array result values 66 for a given adder sub-array 56 represent the numeric result M*R of the product of M (a number represented by a selected portion of bits of the first operand src_a) and R (a number represented by a selected portion of bits of the second operand src_b). For each adder sub-array 56, the portions selected from the first and second operands to represent M and R may be different. To speed up addition of partial products, each adder array 56 may be implemented as a carry-save-adder tree which performs a series of carry-save additions (not carry-propagate additions), which reduces processing time by allowing parallel processing of additions in different bit lanes because there is no dependence of the addition in one bit lane on carries generated in lower bit lanes. Hence, in some examples, the sub-array-result values 66 for a given adder may be represented in a carry-save representation using a sum term and a carry term. To generate a binary result for M*R in a two's complement representation, this may require a further addition of the sum term and the carry term using a carry-propagate adder (not shown in FIG. 9), or if the adder sub-arrays are being used cooperatively to compute a wider multiplication result, the addition of the sum term and carry term can be performed as part of the result assembly addition used to combine results from different adder sub-arrays 56.

The respective adder arrays 56 are sized to handle different data element configurations within the first and second operands. For example, one subset of adder sub-arrays 56 may implement the additions of partial products for respective pairwise multiplications of pairs of 8-bit data elements within the first and second operands. A second subset of adder sub-arrays 56 may implement the partial products additions for respective pairwise multiplications of pairs of 16-bit data elements within the first and second operands. A third subset of adder sub-arrays 56 may implement the partial products additions for respective pairwise multiplications of pairs of 32-bit data elements within the first and second operands. It will be appreciated that this is just one example of different data element configurations that can be implemented. However, it can be useful to provide separate distinct adder sub-arrays sized appropriate to each data element size configuration, rather than implementing all the data element sizes using a single larger adder array, as this can be more energy efficient because it allows the adder sub-arrays 56 corresponding to data element size configurations not required for a given multiplication operation to be disabled to save power.

In this example, each adder sub-array 56 has its own independent enable control signal 64 which is set independently by the enable control circuitry 60 to independently control whether each adder sub-array is currently enabled or disabled. For example, each enable control signal 64 may be a clock signal used to clock components of the adder sub-array 56, so the enable control circuitry 60 may disable a given adder sub-array by clamping the corresponding clock signal to a fixed value. By preventing the clock signal from toggling, the adder sub-array can be disabled and dynamic power is saved. Other implementations may use a different form of enable control, such as power gating where the enable control signal 64 controls enabling/disabling of the adder sub-array 56 by turning on/off a power gate which controls whether the adder sub-array 56 is coupled to or isolated from a power supply node.

Other examples may control the independent enable/disable of the adder sub-array at a coarser granularity, on a subset by subset basis. For example, subsets of adder sub-arrays 56 each corresponding to a given data size could each be provided with an independent enable control signal 64, but adder arrays within the same subset could be enabled/disabled collectively based on the same enable control signal. However, in practice, having independent enable/disable control for each adder sub-array 56 as shown in the example of FIG. 9 can offer greater opportunities for power savings, e.g. by allowing adder sub-arrays 56 corresponding to masked data elements of the first/second operands (elements which are masked by predication) to be disabled to save power, or by allowing adder sub-arrays 56 within a subset to be disabled when they are not required for a multiplication operation applied to operands of operand length shorter than the maximum size supported.

The respective adder sub-arrays 56 can also be used cooperatively to implement a larger multiplication, such as the multiplication of wider portions of bits of src_a and src_b which comprise all magnitude-indicating bits of the first and second operands. When the data element size configuration information indicates that the cooperative mode is to be used, the respective sub-array result values 66 produced by at least a subset of adder arrays (e.g. all of the adder arrays) are added together by the result assembly adder array 58, to produce a product result indicating the numeric value corresponds the product of the wider portions of src_a and src_b than the portions considered by any individual adder array (again, the product may initially be produced by result assembly adder array 58 in a redundant form using separate sum/carry terms, so there may be a further carry propagate adder not shown in FIG. 9 to add the sum and carry terms to generate a single non-redundant product result for the cooperative mode). For example, in one implementation discussed in more detail below, the cooperative mode implements a 64-bit*64-bit multiplication, by adding the product representing values 66 generated by the various adder arrays 56 which in a non-cooperative mode would handle smaller 8-bit, 16-bit or 32-bit multiplications, as well as a further product representing value generated by a further adder array 56 which handles spare bits of the 64-bit multiplication that are not covered by the other adder arrays 56.

Hence, a larger adder array for a multiplier is constructed from a number of smaller (sub) arrays 56. Some of the smaller subarrays are sized (in terms of power and area) for multiplying smaller data types in a non-cooperative mode. The subarrays 56 can also be used cooperatively to construct larger logical arrays (e.g. for the largest data type).

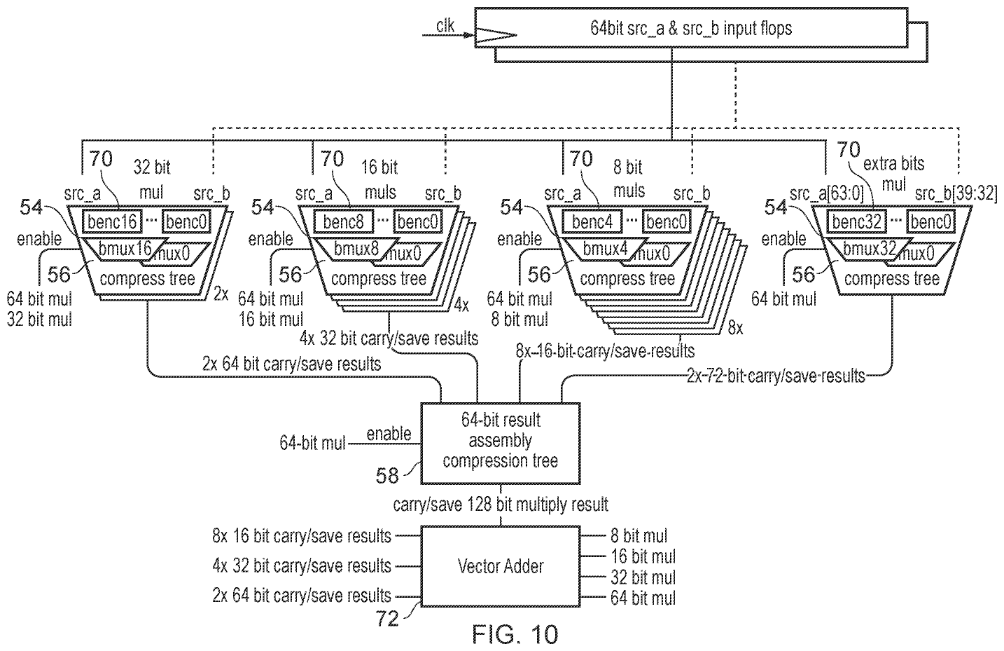

FIG. 10 illustrates a specific example of such a subarray multiplier, in which there are 2 32-bit adder sub-arrays 56, 4 16-bit adder sub-arrays 56 and 8 8-bit adder sub-arrays 56 dedicated to handle partial product additions for 32*32-bit, 16*16-bit and 8*8-bit multiplications respectively. There is also an “extra bits” adder sub-array 56 which adds portions of src_a and src_b that are only required for a cooperative 64-bit multiplication. Each adder sub-array 56 has a corresponding portion of the Booth encoding circuitry 52 (represented by Booth encoders labelled benc0 to benc32). While in this example, each adder sub-array 56 has its own private instance of Booth encoding circuitry 70 for Booth encoding the first operand src_a to generate the partial product selection indicators used by the partial product selection circuitry 54 to select the partial products for that adder array 56, in other examples Booth encoders can be shared between adder sub-arrays so that more than one adder sub-array 56 receives partial products selected based on Booth encodings generated by the same Booth encoder (the same piece of shared hardware circuit logic). An approach for sharing Booth encoders between adder sub-arrays is described in U.S. patent application Ser. No. 18/129,973, the contents of which are entirely incorporated herein within by reference.

When the data element size configuration to be used is 8-bit, 16-bit or 32-bit, the corresponding subset of adder arrays is enabled and each adder array within that subset receives partial products selected depending on a corresponding pair of 8/16/32-bit data elements within the first and second operands src_a, src_b. The results of each adder array can be assembled into a vector result (e.g. by result assembly circuitry 58 which in FIG. 4 is indicated as a single unit shared with the compression tree implementing the cooperative mode adder 58 shown in FIG. 2). In the non-cooperative mode, adder sub-arrays corresponding to a data element size configuration that is not in use can be disabled by the enable control circuitry 60 to save power. Optionally adder sub-arrays corresponding to a data element size configuration that is in use could also be disabled, e.g. if the corresponding data elements they act on are masked by predication or are not required due to operating on a shorter operand length than the maximum operand length supported.

It is possible to operate the adder sub-arrays so that the subsets of adder arrays for more than one of the data element size configurations are enabled in parallel, to produce (based on the same source operands src_a, src_b) a first vector result corresponding to one size configuration (e.g. 32-bit) and a second vector result corresponding to a second size configuration (e.g. 16-bit). This may require the result assembly circuitry to be duplicated to allow for output of multiple independent results in the same cycle.

In the 64-bit cooperative configuration, all the adder sub-arrays are enabled, and the respective product representing values 66 generated by the adder arrays are further added by the result assembly adder tree 58 to produce a 64-bit multiplication result. Optionally, for a multiply-accumulate operation, a further adder 72 may add the multiplication result (or a vector of multiplication results for each data element lane) to corresponding elements of a third operand (still in carry save form to speed up the further adder 72 compared to carry propagate additions).

Optionally, the carry and save terms output by the result assembly circuitry 58 or further adder 72 can be added by a carry propagate adder to produce a result in 2's complement representation, but this is not essential as often the multiply operation may be one of a series of multiply-accumulate operations and so it may be more efficient to retain the result in carry-save form to allow the further adder 72 to perform a faster addition to a previous accumulation result also in carry-save form (with the carry-propagate operation for converting to 2's complement being deferred until after the final accumulation is performed).

If the subarray multiplier is used to implement a signed multiplication operation, this introduces an additional complexity in the result assembly addition performed by the compression tree 58, because the sub-array carry/save results 66 may require sign extension to ensure that the relative sign of each adder sub-array's output is preserved when assembled into the full width product by the result assembly adder array 58. This can introduce a significant amount of additional circuit logic and increase circuit fan out making it challenging to meet circuit timings.

FIG. 11 is a flow diagram which illustrates use of sign extension emulation to reduce the cost of sign extension for a subarray multiplier. At step 200, for each of a plurality of adder sub-arrays 56, a respective set of partial products are added to generate one or more sub-array result values representing a result of a signed multiplication of a respective pair of portions of bits selected from a first operand src_a and a second operand src_b. At step 202, a default zero extension is applied to a sign-extension-emulated sub-array result value regardless of its sign. The sign-extension-emulated sub-array result value could be any of a subset of the sub-array result values 66 produced by the sub-arrays 56 which would otherwise require a sign extension to be applied. By applying a default zero extension regardless of the sign of the value, this avoids the need to include explicit adder cells to inject sign extension bits into the result assembly addition. At step 204, the effect of sign extending the sign-extension-emulated sub-array result value is emulated using at least one other of the assembled values which are to be added in the result assembly addition to be performed by result assembly adder array 58. As will be discussed in more detail below, depending on the type of sign extension the other assembled values can be set in various ways. For example the other assembled values may include at least one static constant set independent of the particular operands being multiplied, and/or one or more single-bit corrections, which can emulate the sign extensions of any of the sub-array result values to which the default zero extension is applied.

At step 206, the result assembly adder array 58 performs the result assembly addition to add the plurality of assembled values, which include the sub-array result values generated by the adder sub-arrays 56 at step 200 (with default zero extensions applied), and may also include one or more additional assembled values such as the constant(s) or single bit corrections mentioned above. The result assembly adder array 58 generates, as a result of the result assembly addition, at least one multiplication result value representing a result of a signed multiplication of the first operand and the second operand.

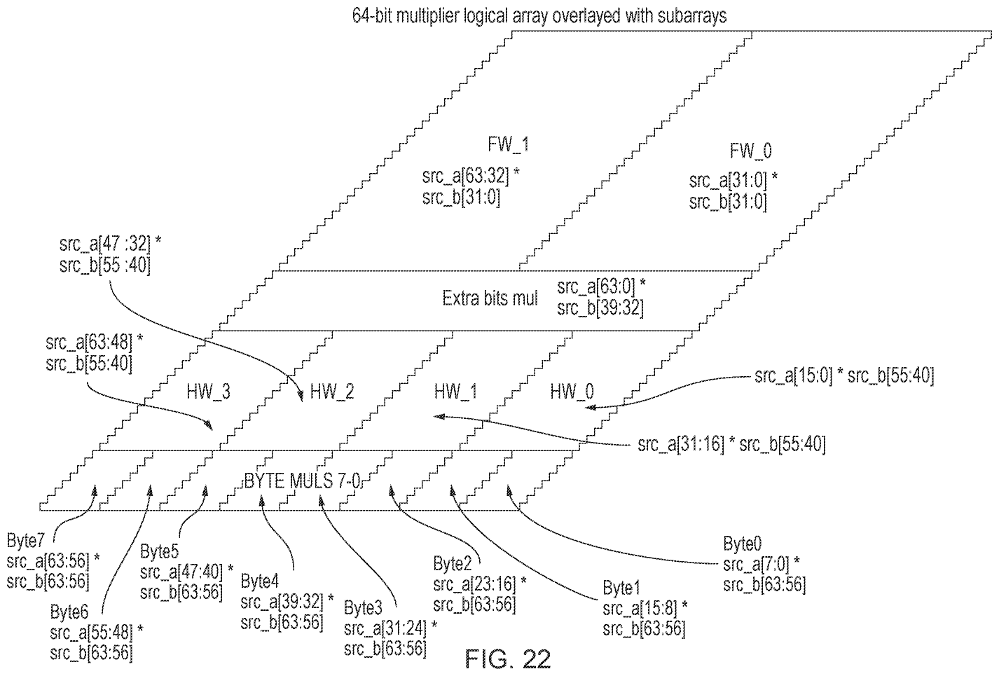

This approach is particularly useful for a subarray multiplier which supports two or more data size configurations, so has a relatively large number of individual adder sub-arrays 56 as shown in FIG. 10, as this can create a need for a greater number of sign extensions. For example, the multiplier in FIG. 10 forms a 64-bit multiplier from 2 32-bit multipliers, 4 16-bit multipliers, 8 8-bit multipliers and one extra bits multiplier. A worked example of using sign extension emulation to reduce the cost of sign extension for this embodiment is described below with respect to FIGS. 22 to 31.

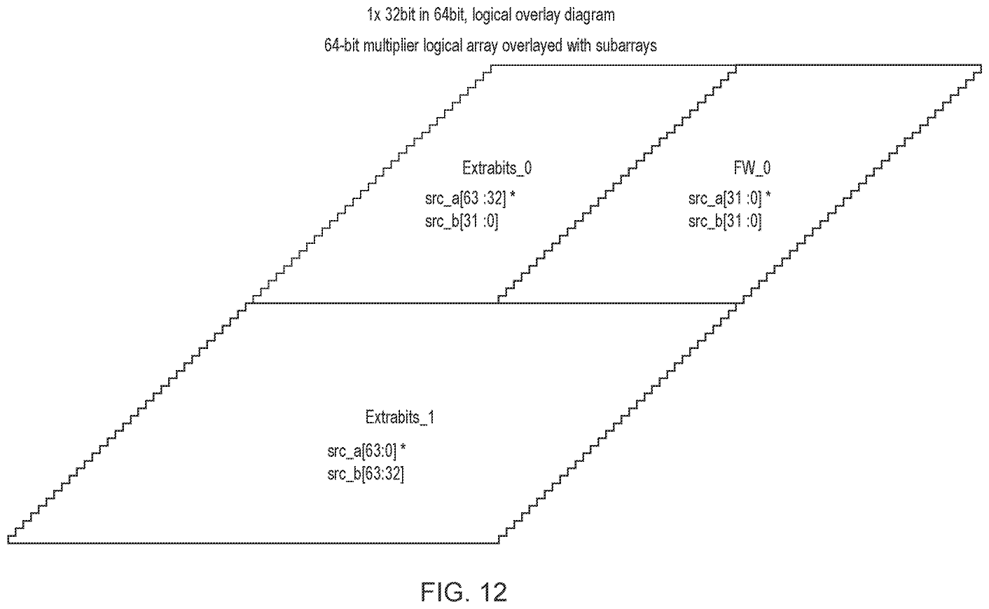

However, to simplify the explanation, the sign extension emulation techniques are first described for a simpler example shown in FIGS. 12 to 21. As shown in FIG. 12, this example assumes a simpler implementation where the 64-bit multiplication in the cooperative mode is implemented using a 32-bit multiplier FW_0, a 32-bit extra bits multiplier “Extrabits_0” and a 32*64 bit extra bits multiplier “Extrabits_1”. FIG. 12 illustrates how, in the cooperative mode, the adder sub-arrays 56 can be assigned respective portions of the first and second operands src_a, src_b to be multiplied based on the additions of partial products by each adder sub-array. The rhombus shape shown in FIG. 12 represents the partial product additions that would be performed if a full-width 64-bit*64-bit multiplication was performed using a traditional “schoolbook” long multiplication method (adding 64 partial products, offset by 1 bit between each row, with a given partial product corresponding to src_a if the corresponding bit of src_b is 1 and corresponding to 0 if the corresponding bit of src_b is 0). It will be appreciated that, as a Booth multiplication scheme is used, the adder sub-arrays do not actually add 64 partial products in this way (the Booth encoding can help to reduce the number of partial products), but it is useful to consider a theoretical example which adds 64 partial products to explore how the portions of src_a and src_b are mapped to the adder sub-arrays and to illustrate the relative alignment of the output of each adder sub-array in the result assembly addition.

Hence, for this simplified example the only data size configurations supported are a 32*32-bit multiplication where adder sub-array FW_0 is used to multiply the lower 32 bits of src_a by the lower 32 bits of src_b and the two extrabits adder sub-arrays 56 are disabled for power saving, and a 64*64 bit multiplication where the three sub-arrays FW_0, Extrabits_0, Extrabits_1 each calculate their respective sub-array results (FW_0 operating in the same way as for the 32*32-bit multiplication, Extrabits_0 multiplying the upper 32 bits of src_a by the lower 32 bits of src_b, and Extrabits_1 multiplying all 64 bits of src_a by the upper 32 bits of src_b).

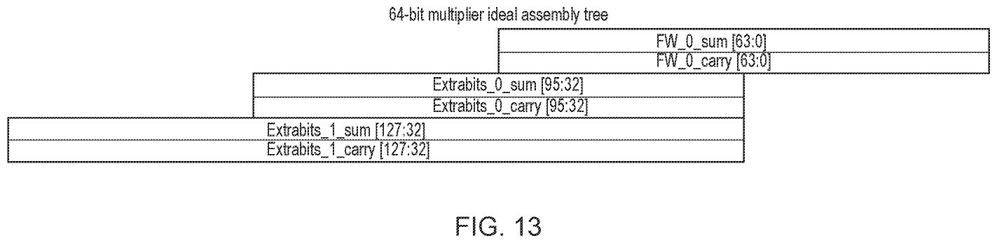

As shown in FIG. 13, in the cooperative mode for the 64-bit multiplication, each of the three adder sub-arrays 56 generates a respective sum term and a carry term. FIG. 13 illustrates the relative alignment of the sum and carry term is generated by each adder sub-array when assembled in the result assembly addition to be performed by result assembly adder array 58—note that this corresponds to the relative column alignment of the “rhombuses” in FIG. 12 within the overall multiplication. FIG. 13 shows the ideal assembly arrangement which could be used if one did not need to account for sign extensions.

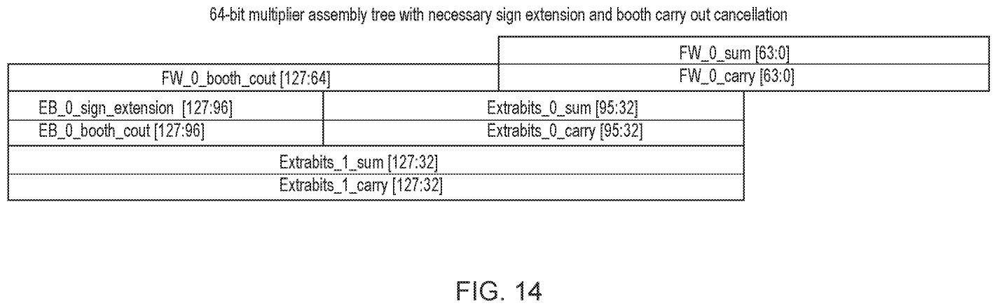

However, as shown in FIG. 14, for a signed multiplication some of the sub-array result values would be sign extended, to account for two different types of sign extension and so preserve the sign of the respective products.

A first type of sign extension “EB_0_sign_extension[127:96]” is shown for the Extrabits_0 sum term. The first type of sign extension would apply for a subarray which produces signed outputs, and for which in the result assembly addition the most significant bit for the result of that sub-array is aligned to a bit of the overall multiplication result other than the most significant bit. A sub-array will produce signed outputs if its inputs includes either source's most significant bit. Hence, in the simplified example of FIG. 14, only one of the sub-arrays (Extrabits_0) requires the first type of sign extension as FW_0 does not consume the most significant bit of either source operand and the result of Extrabits_1 already extends all the way up to the most significant bit of the overall multiplication result. For the first type of sign extension, each bit in the portion denoted as “EB_0_sign_extension[127:96]” would need to be set to the same value as the top bit of Extrabits_0_sum.

A second type of sign extension “FW_0_booth_cout[127:54]” and “EB_0_booth_cout[127:96]” is shown for the FW_0 and Extrabits_0 carry terms, and arises because the sum and carry terms from these sub-arrays were not added together by a carry propagate adder before starting the result assembly addition. If a carry propagate addition had been performed on the sum and carry terms before the result assembly addition started, that carry propagate addition could have caused a carry out which if set to 1 would represent a negative signed result, and so require a sign extension when combined with other results in the result assembly addition. Hence, the sign extension “FW_0_booth_cout[127:54]” would have each bit set equivalent to the carry out which would be generated in an addition of FW_0_sum and FW_0_carry, while the sign extension bits for “EB_0_booth_cout[127:96]” would have each bit set equivalent to the carry out which would be generated in an addition of Extrabits_0_sum and Extrabits_0_carry.

Hence, the result assembly addition requires a significant number of additional sign extension bits to be injected into the assembly tree, which not only requires additional circuit logic compared to an unsigned addition, but also increases the amount of circuit fanout since the sign extension bits depend on bits derived from the sum/carry values from the respective adder arrays and once introduced at one row of the addition tree cause subsequent rows of adder cells to depend on the output of the previous row. This increased circuit fanout causes longer critical path lengths, putting greater pressure on meeting circuit timings, which may tend to limit the maximum clock frequency that can be supported. Hence, sign extensions can be costly in terms of performance.

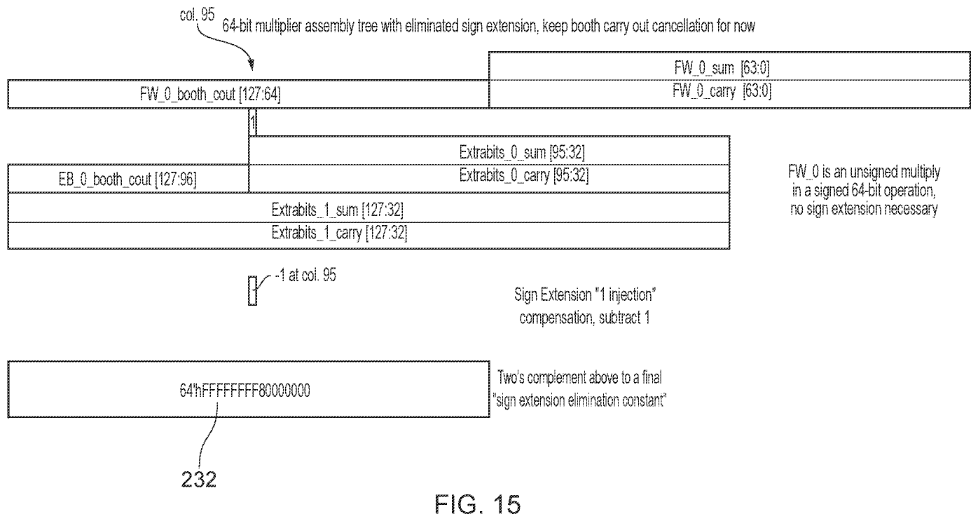

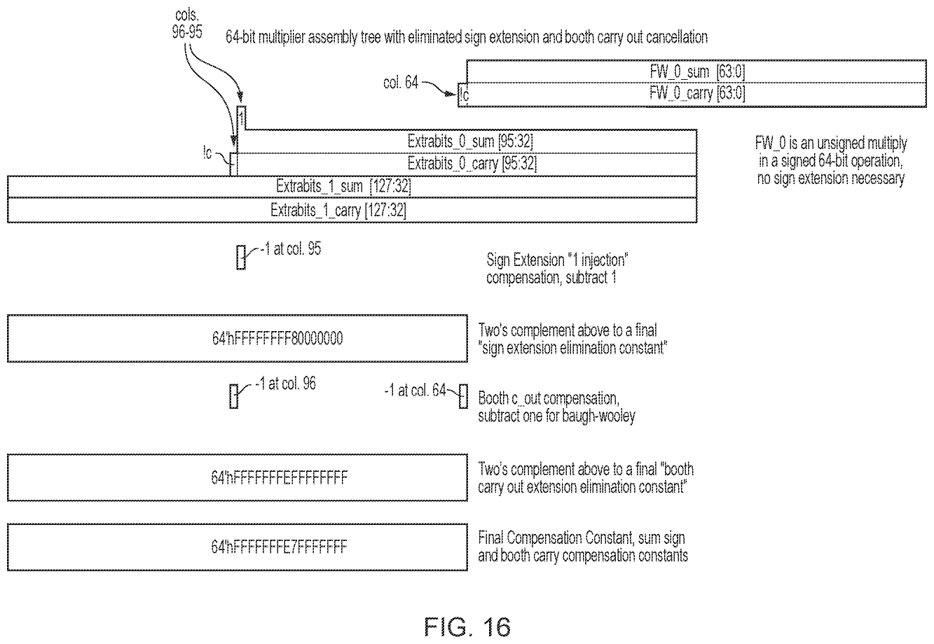

FIG. 15 illustrates a first type of sign extension emulation that can be used to eliminate the first type of sign extension (for now, the second type of sign extension indicated by the “booth_cout” terms is left as in FIG. 14). In this example, the sign-extended-emulated sub-array result value is FW_0_sum (the value to be sign extended using this first type of sign extension). It is recognised that:
If the value to be sign extended is negative, its msb (most significant bit, shown bold underlined) is 1 and the sign extension would be S . . . SSS1xxxxxx where the bits denoted by S are the sign extension bits and are also equal to 1.
For a negative signed value subject to sign extension, adding 1 at the most significant bit of the value being sign extended causes the sign-extended value to change from 1 . . . 1111xxx . . . xxx to (1)0 . . . 0000xxx . . . xxx, where the 0 bit shown bold underlined is the bit at the corresponding msb position in the value being sign extended, and the bracketed 1 represents a carry out of 1 which can be ignored as it will be cancelled out by the −1 correction described below). This adjusted value does not require any explicit adder cells to add the 0s above the most significant bit position, but is too high compared to the value that should have been added (it represents 10 . . . 0000xxx . . . xxx instead of 01 . . . 1111xxx . . . xxx).
Hence, to obtain the correct result, it would also be needed to subtract 1 at the msb of the value being sign extended.
On the other hand, if the original value to be signed extended had been positive, its msb would be 0 and the sign-extension would be S . . . SSS0xxxxxx where the bits marked S are the sign extension bits and are also equal to 0.
If +1 was added at the msb of the positive value being sign extended, this would not cause any 1 to propagate beyond the msb itself (0+1=1), so the sign extension bits S would stay as 0: the value after +1 being added at msb position would become S . . . SSS1xxxxxx. Again, the value is too high—it represents 0 . . . 0001xxx . . . xxx instead of 0 . . . 0000xxx . . . xxx. Subtracting 1 at the msb of the value being sign extended again restores the correct value. Therefore, as shown in FIG. 15, regardless of whether the original value was positive or negative, the sign extension can be emulated by:
adding a correction value of +1 at the msb of the value being sign extended-see correction in column 95 at the msb of Extrabits_0_sum; and
subtracting −1 at the msb of the value being sign extended.
   The −1 correction can be represented by a single static constant 232. For the example of FIG. 16, this constant becomes 64′hFFFFFFFF80000000 which represents in two's complement form the effect of subtracting 1 at column 95 (column 95 corresponding to the msb of Extrabits_0_sum). The +1 correction can be applied within the adder sub-array itself (e.g. by the Extrabits_0 adder sub-array), at the time of generating the adder sub-array result which is being sign extended, so that it is not necessary for the +1 correction to be considered by the result assembly adder array. An alternative would be to combine the +1 correction into the constant representing the −1 correction.

Hence, the +1 correction in combination with the additional assembled value 232 (constant) emulates the effect of sign-extending the Extrabits_0_sum sub-array result, and means a default zero extension can be applied to that sub-array result to avoid needing to include in the result assembly addition tree the EB_0_sign_extension sign extension bits (shown for comparison in FIG. 14). The constant 232 is a static term that does not depend on the specific operands being multiplied, so can be hardwired or read out in advance, and does not depend on the specific sub-array result values 66 from the adder arrays 56. Therefore, the assembled value 232 used to emulate sign extension does not contribute to increased fan out, unlike the original sign extension bits it emulates which depend on the msb of the value being sign extended.

FIG. 16 illustrates a second type of sign extension emulation that can be used to eliminate the second type of sign extension (a sign extension used to extend a sign represented by the carry out bit which would have been generated if the sum and carry terms generated by a given adder sub-array 56 were added together before the result assembly addition, but which is missing from the values added in the result assembly addition because the result assembly addition consumes the sum and carry terms from the given adder sub-array 56 directly without an intervening carry propagate addition). There may be more than one of the adder sub-arrays 56 whose results may use such second type of sign extension emulation-any of such adder sub-arrays can be treated as the given adder sub-array 56 mentioned below.

Similar to the first type of sign extension, the second type of sign extension is based on applying a one-bit correction and an adjustment of −1, but the second type of sign extension differs from the first type of sign extension in that:
the one bit correction is a value !c which has the opposite sign to the carry out bit which would have been generated from the addition of the sum and carry terms produced by the given adder sub-array. As noted below, this can be calculated by the given adder sub-array based on additional bits carried through the adder reduction tree in sub-array 56;
both the !c correction and the −1 adjustment are applied at the bit position ‘msb+1’, which is one place higher than the position corresponding to the most significant bit of the sum term for the given adder sub-array;
   This works because:
if the carry out bit c had been generated by a carry propagate addition of the sum/carry terms, that carry out bit would have been located at the position ‘msb+1’.
if the carry out bit c was 1, its sign extension would result in there being 1s at position ‘msb+1’ and all more significant bits up to the top bit of the overall result of the result assembly addition—this is equivalent to subtracting 1 at position ‘msb+1’. Hence, for the case where a carry is 1, subtracting 1 at position msb+1 would be enough to give the correct outcome. To avoid problems of increased fanout, it is desirable for this −1 adjustment to be implemented using addition of a static constant which is independent of the values of the operands.
if the carry out bit c was 0, its sign extension would cause there to be 0s at position ‘msb+1’ and all more significant bits up to the top bit of the overall result of the result assembly addition—i.e. no sign extension would be necessary in this case. However, using the static constant to apply the −1 subtraction at position ‘msb+1’ to deal with the case where the carry out bit c was 1 means that when c=0 then the result is too low. This is corrected by applying a 1-bit correction of +1 at position ‘msb+1’.
Hence, a static injection of −1 at position ‘msb+1’, combined with +1 only in the case when the carry out c=0, gives the correct result. When c=1, there is no need for the +1 correction and so injecting 0 gives the correct result. Therefore, the 1-bit correction has the opposite value from the carry out bit c, i.e. the correction should be !c (NOT c).
Therefore, the 1-bit correction of !c combined with a static subtraction of −1 in the same column gives the correct outcome in both cases where c=0 and where c=1. The 1-bit correction means there is only one column which depends on the carry status, not all the columns more significant than the msb position as in the traditional sign extension approach shown in FIG. 15, so this helps to reduce fanout.
   For example, as shown in FIG. 16, the FW_0 and Extrabits_1 sub-arrays produce sum and carry terms which have their most significant bit aligned to bits 63 and 95 respectively within the result assembly result, so the 1 bit corrections !c and subtractions of 1 are applied in column 64 for FW_0 and column 96 for Extrabits_1. The two instances of −1 for dealing with the booth carry out extension elimination can be combined to provide a constant of 64′hFFFFFFFEFFFFFFF, and this constant can be combined with the constant 64′hFFFFFFFF80000000 used to eliminate the first type of sign extension as discussed for FIG. 15, to give a combined compensation constant 64′hFFFFFFFE7FFFFFFF which implements all three of the −1 contributions used to eliminate the true sign extension for Extrabits_0 and the carry out sign extension for FW_0 and Extrabits_0.

The !c correction at position msb+1 relative to a given adder sub-array's output represents whether addition of the sum and carry terms from that given adder sub-array would generate a carry out. It would not be desirable to actually add the sum and carry terms to find the !c correction, because this would be counter to the purpose of consuming the sum and carry terms directly in the result assembly addition, which is to eliminate the delay of such a carry propagate addition. Therefore, instead the value of !c can be estimated by carrying additional bits through the carry-save adder tree used to add the partial products within the given adder sub-array 56. Normally, for generation of N-bit sum/carry values, at each level of the carry save adder reduction tree, the output of that level would be truncated at bit N−1 to give an N-bit value [N−1:0] which is passed to a subsequent level of the reduction tree. However, to support the second type of sign extension emulation, instead the value at each level of the reduction tree is extended to bit N, and the carry out bit can then be calculated from an OR of the final sum and carry's MSB+1 bits.

For example, the pseudocode below shows a simplified example for an 8-bit*8-bit multiplication using a subarray, to produce what would normally be a 16-bit result, but which is provided with 17 bits [16:0] so that the !c term can be estimated without needing a full carry propagate addition of the sum/carry terms pps_o, ppc_o. Note that each level of the 3:2 reduction tree, including the final level producing the sum and carry terms pps_o, ppc_o to be consumed in the result assembly addition, extends to bit [16]. The final line of the pseudocode calculates the !c term as the inverse of the OR of bit of the sum and carry terms.

// level t0 3:2 reduction

| | |
|---|---|
| assign t0fa0ina[15:0] = {4′b0000, | t0pp0[11:0]}; |
| assign t0fa0inb[15:0] = {3′b000, | t0pp1[12:0]}; |
| assign t0fa0inc[15:0] = { | t0pp2[15:2], 2′b00}; |

```
assign t2pp0s[15:0] =  t0fa0ina[15:0] \hat{ } t0fa0inb[15:0] \hat{ } t0fa0inc[15:0];
assign t1pp0c[16:1] = (t0fa0ina[15:0] & t0fa0inb[15:0])
                  | (t0fa0ina[15:0] & t0fa0inc[15:0])
                  | (t0fa0inb[15:0] & t0fa0inc[15:0]);
// level t1 3:2 reduction
```

| | |
|---|---|
| assign t0fa1ina[16:4] = { {8{1′b0}}, | t0pp5[ 8], {4{1′b0}}}; |
| assign t0fa1inb[16:4] = { | t0pp3[16:4] }; |
| assign t0fa1inc[16:4] = { | t0pp4[16:6], {2{1′b0}}}; |

```
assign t2pp1s[16:4] =  t0fa1ina[16:4] \hat{ } t0fa1inb[16:4] \hat{ } t0fa1inc[16:4];
assign t1pp1c[16:5] = (t0fa1ina[15:4] & t0fa1inb[15:4])
                  | (t0fa1ina[15:4] & t0fa1inc[15:4])
                  | (t0fa1inb[15:4] & t0fa1inc[15:4]);
// level t2 3:2 reduction
```

| | |
|---|---|
| assign t2fa0ina[16:1] = { | t1pp1c[16:5], { 4{1′b0}}}; |
| assign t2fa0inb[16:1] = { | t1pp0c[16:1] }; |
| assign t2fa0inc[16:1] = { | t2pp1s[16:4], { 3{1′b0}}}; |

```
assign t4pp0s[16:1] =  t2fa0ina[16:1] \hat{ } t2fa0inb[16:1] \hat{ } t2fa0inc[16:1];
assign t3pp0c[16:2] = (t2fa0ina[15:1] & t2fa0inb[15:1])
                  | (t2fa0ina[15:1] & t2fa0inc[15:1])
                  | (t2fa0inb[15:1] & t2fa0inc[15:1]);
// level t3/4 3:2 reduction
```

| | |
|---|---|
| assign t4fa0ina[16:0] = {{ 1{1′b0}}, | t2pp0s[15:0] }; |
| assign t4fa0inb[16:0] = { | t3pp0c[16:2], {2{1′b0}} }; |
| assign t4fa0inc[16:0] = { | t4pp0s[16:1], {1{1′b0}} }; |

```
assign pps_o[16:0] =  t4fa0ina[16:0] \hat{ } t4fa0inb[16:0] \hat{ } t4fa0inc[16:0];
assign ppc_o[16:1] = (t4fa0ina[15:0] & t4fa0inb[15:0])
                  | (t4fa0ina[15:0] & t4fa0inc[15:0])
                  | (t4fa0inb[15:0] & t4fa0inc[15:0]);
assign ppc_o[0] = 1′b0;//c_in & smul;
// use extra gates to carry 16 bits through sum terms so this OR is shorter
// c_out used as !c in 64bit CSA assembly tree in simd_mul
assign c_out = ~(ppc_o[16] | pps_o[16]);
```

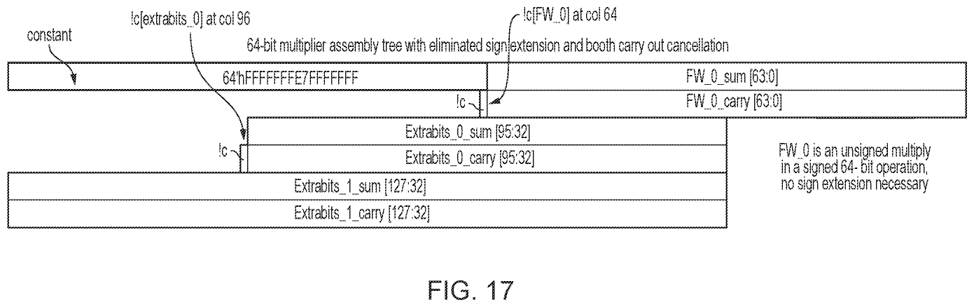

FIG. 17 puts together the approaches for dealing with the first and second types of sign extension. The result assembly addition comprises, as the assembled values, the sum and carry terms from each of the three adder sub-arrays 56 (FW_0, Extrabits_0, Extrabits_1), 1-bit corrections !c[FW_0] at column 64, 1 at column 95, and !c[Extrabits_0] at column 96, and the static constant 64′hFFFFFFFE7FFFFFFF which implements the combined effect of −1 at each of columns 64, 95 and 96. Also, the assembled values include 1-bit corrections !c at column 64 based on the c_out determined by the FW_0 adder sub-array and !c at column 96 based on the c_out determined by the Extrabits_0 adder sub-array 56. The 1-bit correction +1 for emulating the true sign extension (first type of sign extension) of the Extrabits_0 sub-array result is applied within the Extrabits_0 adder sub-array 56, and so is not shown in FIG. 17.

This emulates the combined effect of: a true sign extension of the sign bit (at column 95) for the Extrabits_0 result, and the Booth carry out cancellation sign extension at columns 64 and 96 for the sum/carry terms of FW_0 and Extrabits_0. Extrabits_1 does not need any sign extension to be emulated, because it already extends up to the most significant bit 127 of the multiplication result. It can be seen that, compared to FIG. 14, a large number of sign extension bits are eliminated from the result assembly addition, reducing circuit area and improving performance by reducing fanout.

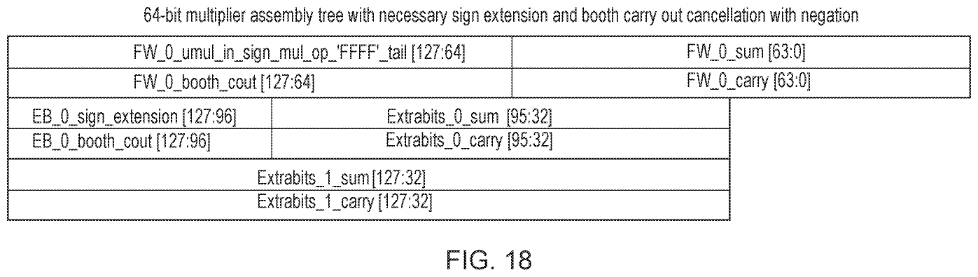

FIG. 18 shows a third type of sign extension that may be performed in some examples which support a signed multiplication with negation, for which the result depends on −1*src_a*src_b. For the adder sub-arrays which consume a sign bit of one of the input operands (e.g. Extrabits_0), this can be dealt with simply by flipping the sign bit of one of the input operands and then emulating the first/second types of sign extension in the same way as discussed above.

However, with the negated signed multiplication, sign extension also becomes relevant for those sub-arrays 56 which act on portions of the first and second operands src_a, src_b which do not include any sign bit (e.g. see FW_0 in the example of FIG. 12). For a non-negated multiplication, given use of a two's complement representation where the top bit is weighted negatively and all other bits are weighted positively, the output of FW_0 which does not consume either operand's sign bits would be weighted positively regardless of the overall sign of the operands, and so the first type of sign extension (true sign extension) is not needed. However, for a negated multiplication, the output of an adder sub-array which does not consume the sign bit of either input operand opa, opb does require sign extension, to convert its positive output to a negative value. The negation will cause the top bit of the FW_0 output (at the MSB+1 position) to become 1 indicating a negative value which when assembled with the other values therefore requires sign extension up to the top bit of the multiplication result, to preserve the negative sign of the FW_0 output. In FIG. 18, the term “FW_0_umul_in_sign_mul_op_‘FFFF’_tail[127:64]” represents a third type of sign extension used for unsigned adder sub-arrays in a negated multiplication. This type of sign extension would, in the traditional approach, be performed by including 1s at all bits more significant than the most significant bit of the value being sign extended (e.g. for FW_0 with most significant bit at position 63, bits 127:64 all become 1). FIG. 18 shows the third type of sign extension in combination with the first and second types of sign extension, which in FIG. 18 have not yet been eliminated by the first/second types of sign extension emulation discussed above for FIGS. 14 to 17.

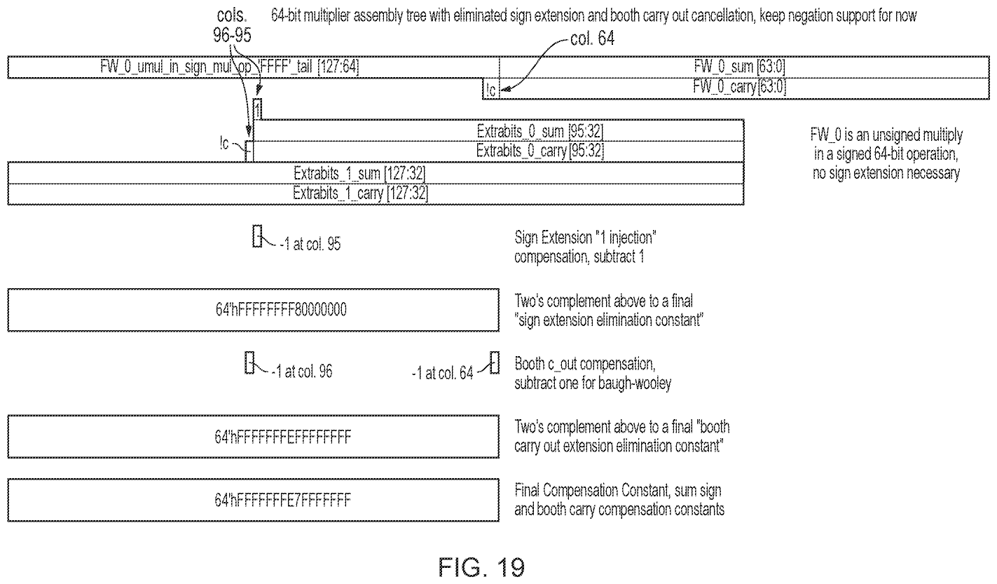

FIG. 19 shows the first and second types of sign extension being eliminated by applying the first/second sign extension emulation techniques discussed above (note that FIG. 19 is the same as FIG. 16 except for the inclusion of the additional third type of sign extension “FW_0_umul_in_sign_mul_op_‘FFFF’_tail[127:64]” to deal with the negated multiplication operation.

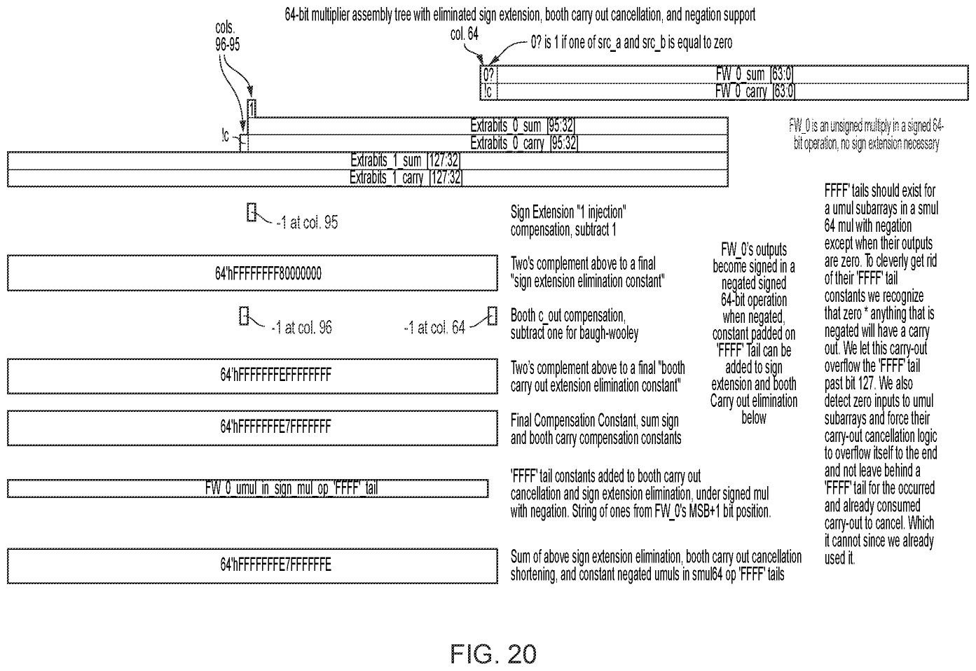

FIG. 20 shows the third type of sign extension emulation for a given adder sub-array 56 which does not consume either of the first and second operands' sign bits (in this example, FW_0 is the only given adder sub-array which uses the third type of sign extension emulation). The third type of sign extension emulation is performed by including in the assembled values to be added in the result assembly addition:
a 1-bit correction “0?” aligned to the msb+1 bit position (one place higher than the most significant bit of the sum output of the given adder sub-array which requires the third type of sign extension). “0?”=1 if either of the first and second signed operands is equal to zero, and “0?”=0 if both of the first and second signed operands are non-zero.
a constant which implements adding 1s at all bit positions more significant than the most significant bit of the sum output of the given adder sub-array.
   This reflects that, in all cases other than when either (or both) of the portions of the operands being multiplied by the given adder sub-array is zero, in a signed negated multiplication (−1*src_a*src_b) the product of lower sub-portions of src_a, src_b represented by the sum/carry outputs of the given adder sub-array 56 will have a non-zero value. To ensure negative weighting in the result assembly addition, a sign extension should be applied to inject 1s at all positions more significant than the most significant bit of the sum output of that given adder sub-array. Therefore, the addition of a series of 1s at those more significant bit positions gives the correct sign extension result in most cases. However, in the case where the portions of either src_a or src_b being processed by the given adder sub-array are 0, it would be incorrect to sign extend with a string of 1s, as in that case the output of the sub-array represents 0 (as anything multiplied by 0 gives a result of 0). When zero is negated, the negated value is still 0, which should be represented in two's complement by all 0s. However, as the static constant adds 1s at all bits above msb every time, in the case where one of the inputs is 0, this can be corrected for by also adding a 1-bit correction at position msb+1, which cancels out the 1s and gives the correct result.

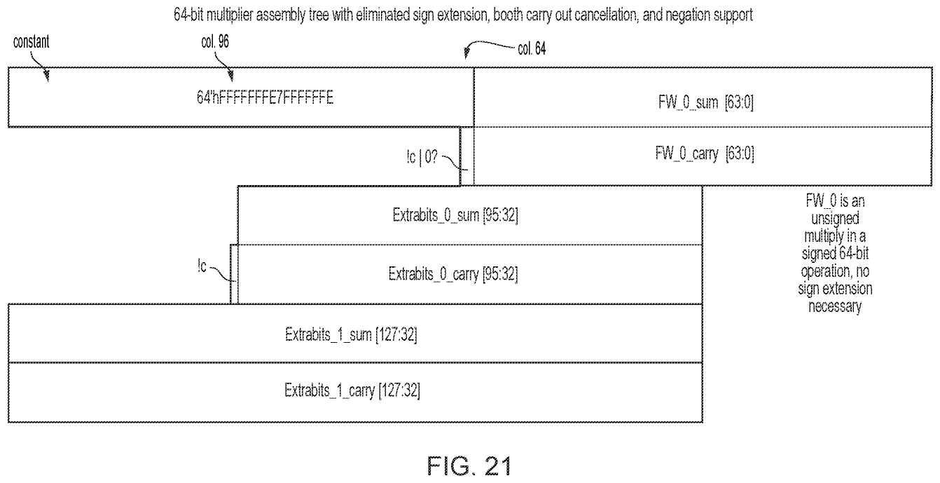

As the constant “FFFF . . . ” is static, it does not need to depend on the inputs, so can be combined with other constants used for other sign extensions as shown in FIG. 21. In FIG. 21, the constant 64′hFFFFFFFE7FFFFFFFE represents the combined effect of the various constants applied in FIG. 20 as part of emulation of:
the first type of sign extension (true sign extension based on sign bit) for Extrabits_0;
the second type of sign extension (sign extension of carry out bit which would have been generated if sum/carry terms had been added before being consumed in the result assembly addition) for FW_0 and Extrabits_0;
the third type of sign extension (sign extension of negated output) for FW_0.
   By combining these constants into one, this reduces the depth of the adder tree used for the result assembly adder array 58.

Also, as shown in FIG. 21, the combined elimination of the second and third types of sign extension introduces some 1-bit correction values into the result assembly addition (the first type of sign extension can be handled using the constant alone as the +1 term shown in FIG. 15 is static):
a correction of src_b.c at column 96, calculated based on the additional bits carried through the Extrabits_0 adder reduction tree as noted above, for use in the second type of sign extension emulation for Extrabits_0; and
at column 64, a value !c|0? which represents the OR of the corrections used for the second and third type of sign extension emulation:
   !c indicating whether addition of the sum/carry terms output by FW_0 would have generated a carry out; and
   0? indicating whether either of the portions of either src_a, src_b, or both being processed by the adder sub-array is 0.

FIGS. 22 to 31 show a second example applying the first, second and third types of sign extension emulation described above to the specific subarray multiplier shown in FIG. 10 which forms a 64-bit multiplier from 2 32-bit multipliers, 4 16-bit multipliers, 8 8-bit multipliers and one extra bits multiplier. FIG. 22 illustrates how portions of the overall 64-bit*64-bit multiplication are assigned to the respective adder sub-arrays 56, with each sub-array performing the partial product additions for adding partial products obtained by Booth encoding for a corresponding multiplication of sub-portions of the 64 bit operands src_a, src_b. As shown in FIG. 22 once the 32-bit, 16-bit and 8-bit adder sub-arrays 56 (sized for handling smaller multiplications for other data types) are assigned portions of the 64-bit multiplication, this leaves the extra bits adder array to handle partial product additions for a 64-bit*8-bit multiplication.

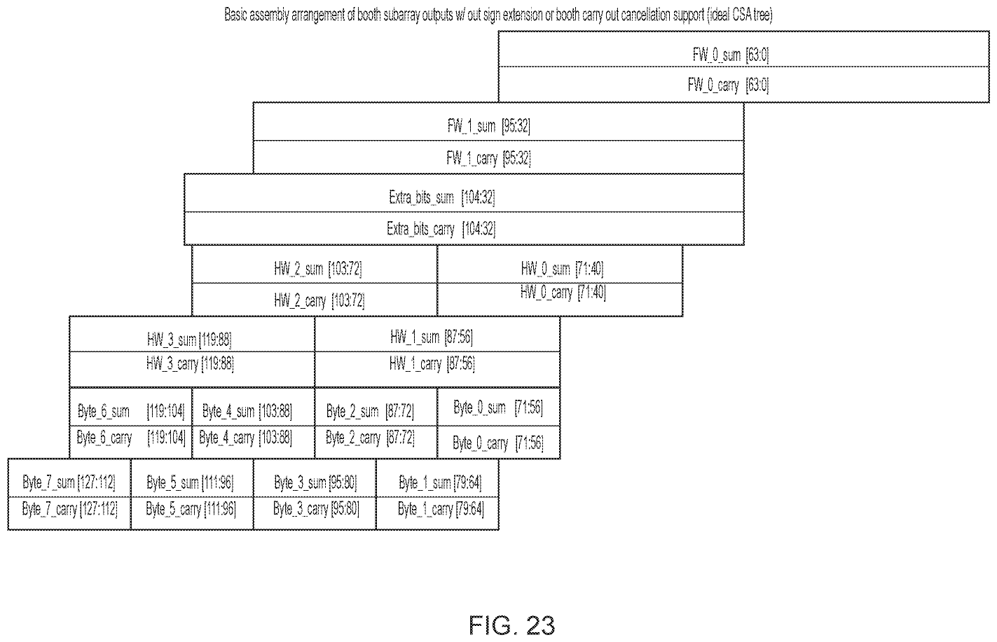

FIG. 23 illustrates the result assembly addition performed by result assembly adder array 58. FIG. 23 shows an ideal arrangement of the sum/carry terms produced by each adder sub-array 56, without showing any of the sign extensions. The result assembly addition adds a set of assembled values, including at least a sum term and a carry term for each of the individual adder sub-array 56: where FW_0, FW_1 refer to the two 32-bit adder sub-arrays, HW_0 to HW_3 refer to the four 16-bit adder sub-arrays, and Byte_0 to Byte_7 refers to the eight 8-bit adder sub-arrays, and “Extra_bits” refers to the extra bits adder sub-array. The relative alignment of the sum/carry terms from each adder sub-array 56 corresponds to the mapping shown in FIG. 22 onto the portions of the 64-bit multiplication. Although the “Extra_bits” sum and carry terms could have been represented using 72 bits aligned to bits [103:32] of the result assembly addition, in this example it is represented using 73 bits aligned to [104:32]—the extra bit aligned to bit being a sign extension of the bit at position [103]. In other examples, other sub-array results could be arbitrarily extended to extra length. Such artificial extension of a given sub-array result can be used if it is desired to adjust the bit position at which a corresponding 1-bit correction is applied for sign extension emulation.

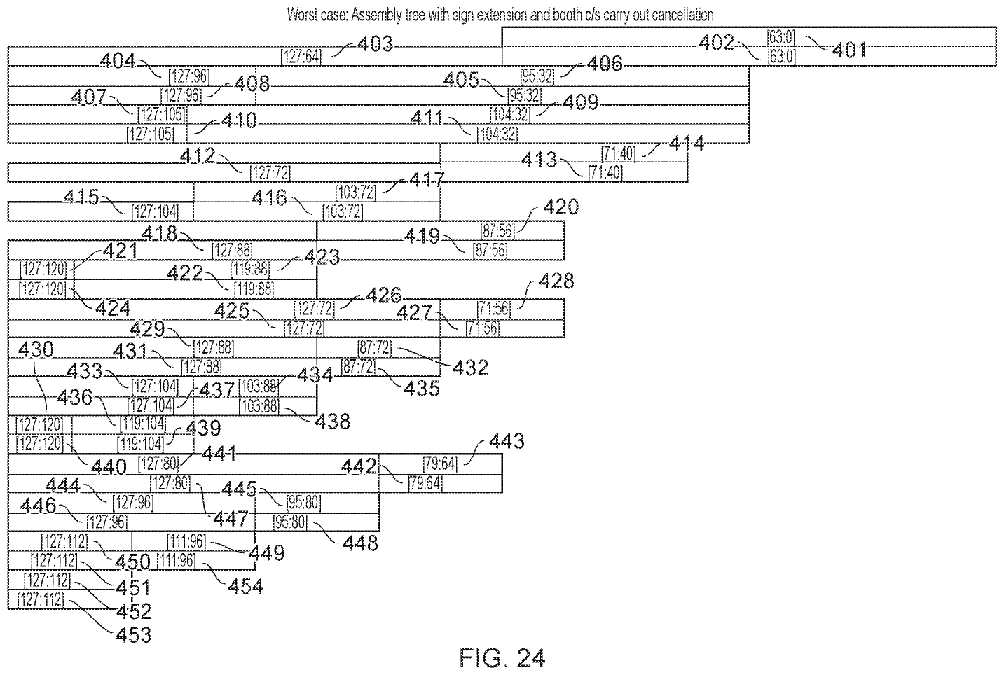

FIG. 24 illustrates the result assembly addition including sign extension terms for handling the first type of sign extension (true sign extension of a sign bit for FW_1 (404), Extra_bits, HW_3, and Byte_0 to Byte 6, which are the adder sub-arrays which consume the sign bit of one of the source operands src_a, src_b) and second type of sign extension (sign extension of the carry out bit that would have arisen had the sum/carry terms been added by a carry propagate adder before the result assembly addition—this is applied for all adder sub-arrays except Byte_7, which does not need any sign extension as its sub-array result value is already aligned to the most significant bit of the multiplication result).

In FIGS. 24-26 and 28-30, reference numerals refer to terms according to the following mapping:
401: FW_0_sum
402: FW_0_carry
403: FW_0_booth_cout
404: FW_1_sign_extension
405: FW_1_carry
406: FW_1_sum
407: Extra_bits_sign_extension
408: FW_1_booth_cout
409: Extra_bits_sum
410: Extra_bits_booth_cout
411: Extra_bits_carry
412: HW_0_booth_cout
413: HW_0_carry
414: HW_0_sum
415: HW_2_booth_cout
416: HW_2_carry
417: HW_2_sum
418: HW_1_booth_cout
419: HW_1_carry
420: HW_1_sum
421: HW_3_sign_extension
422: HW_3_carry
423: HW_3_sum
424: HW_3_booth_cout
425: Byte_0_booth_cout
426: Byte_0_sign_extension
427: Byte_0_carry
428: Byte_0_sum
429: Byte_2_sign_extension
430: Byte_6_sign_extension
431: Byte_2_booth_cout
432: Byte_2_sum
433: Byte_4_sign_extension
434: Byte_4_sum
435: Byte_2_carry
436: Byte_6_sum
437: Byte_4_booth_cout
438: Byte_4_carry
439: Byte_6_carry
440: Byte_6_booth_cout
441: Byte_1_sign_extension
442: Byte_1_carry
443: Byte_1_sum
444: Byte_3_sign_extension
445: Byte_3_sum
446: Byte_3_booth_cout
447: Byte_1_booth_cout
448: Byte_3_carry
449: Byte_5_sum
450: Byte_5_sign_extension
451: Byte_5_booth_cout
452: Byte_7_sum
453: Byte_7_carry
454: Byte_5_carry
546: 64′h FEFF_7E7E_FF7F_7F80
641: 64′h FDFE_FBFD_FDFE_FDFF
642: 64′h FCFE_7A7C_FD7E_7D7F
701: FW_0_umul_in_sign_mul_op_‘FFFF’_tail
714: HW_0_umul_in_sign_mul_op_‘FFFF’_tail
717: HW_2_umul_in_sign_mul_op_‘FFFF’_tail
722: HW_1_umul_in_sign_mul_op_‘FFFF’_tail
915: 64′h FCFE_797C_FC7E_7C7E

As can be seen from comparing FIG. 24 with FIG. 15, for the more complex subarray multiplier, the problem of partial product growth due to sign extensions is a much greater problem, and if handled in the traditional method would introduce a large amount of additional circuit logic and fanout into the result assembly addition.

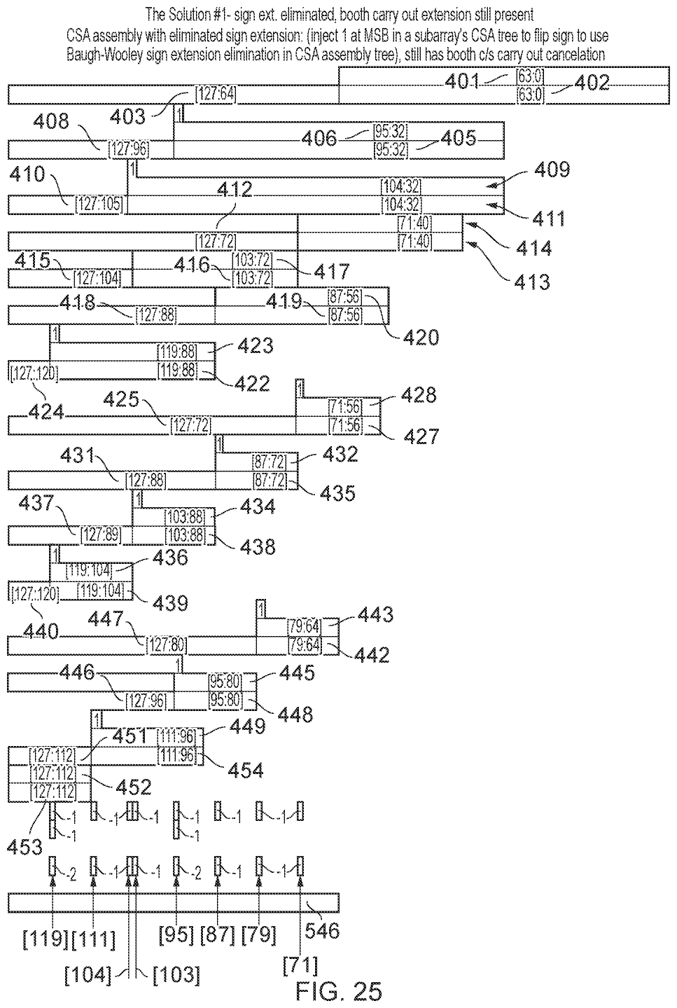

FIG. 25 illustrates the first type of sign extension emulation, for eliminating the true sign extensions (for ease of explanation, the carry out sign extensions are still present for now). In the same way as for the simpler example, each instance of a true sign extension is addressed by applying a 1-bit correction +1 at the bit position of the most significant bit of the value to be sign extended, and also subtracting 1 at that most significant bit position. In this example, the sub-arrays requiring the first type of sign extension would be FW_1, Extra_bits, HW_3, and Byte_0 to Byte_6, and the msb positions for those sub-arrays are in columns 95, 104, 119, 71, 79, 87, 95, 103, 111 and 119 respectively. Columns 95 and 119 therefore end up having two +1 corrections and two −1 adjustments applied, so the −2 correction is shown as −2. All the −1 adjustments for each sub-array (including the +2/−2 in the columns 95 and 119) can be combined into a single constant of 64′h FEFF_7E7E_FF7F_7F80 (546) (aligned to bits 127:64 of the multiplication result). The +1 corrections can be applied by the relevant adder sub-arrays which generate the sub-array results subject to the +1 corrections (although in other examples the +1 corrections could also be combined into the correction constant 546). This eliminates the need for the terms “ . . . _sign_extension” shown in FIG. 24 and replaces them with static constants which therefore reduces fanout and helps improve performance.

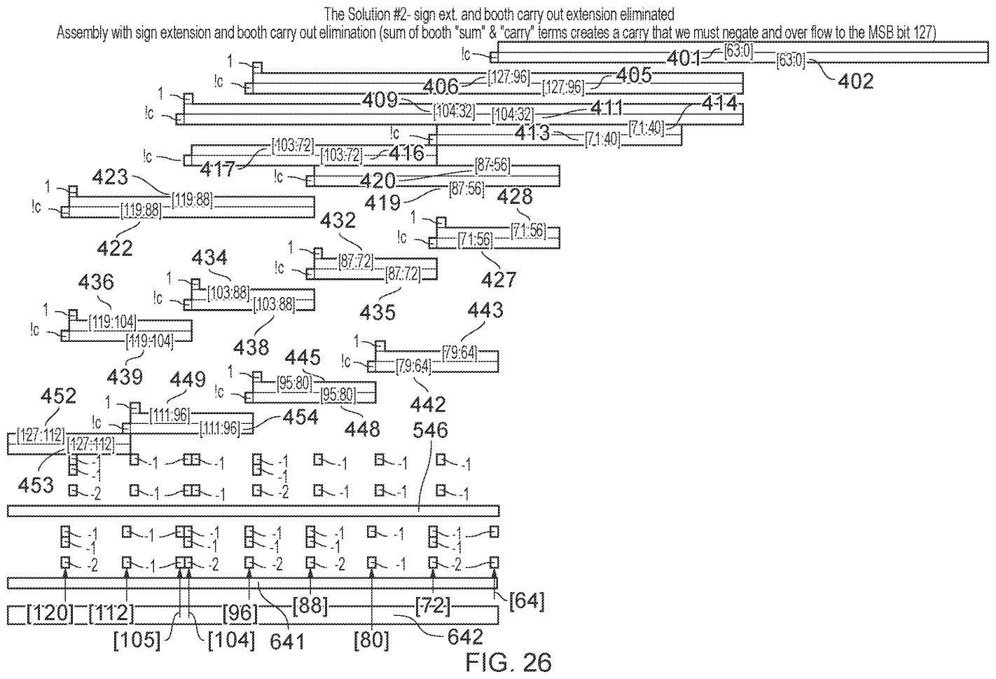

FIG. 26 illustrates the second type of sign extension emulation, for eliminating the extensions of the carry outs which would be generated if the carry/sum terms had been added before the result assembly addition. For all the adder sub-arrays except Byte7, there is now a 1-bit correction of !c (the inverse of the carry bit calculated based on msb+1 of the sum/carry outputs from the corresponding adder array as described earlier for the simpler example—note that the value of !c can be different for each adder sub-array depending on its operand inputs), with the !c correction being applied in the column corresponding to the msb+1 position for that adder sub-array. There is also a corresponding −1 adjustment at the same msb+1 position. Hence, for the respective adder sub-array outputs, the result assembly adder array 58 applies the !c correction and −1 adjustment at columns 64 (for FW_0), 72 (for HW_0 and Byte_0), 80 (for Byte_1), 88 (for HW_1 and Byte_2), 96 (for FW_1 and Byte_3), 104 (for HW_2 and Byte_4), 105 (for Extra_bits), 112 (for Byte_5) and 120 (for HW_3 and Byte_6). This means there is a −2 adjustment in columns 72, 88, 104, 120 and −1 adjustment in columns 64, 80, 105, 112—the resulting constant becomes 64′h FDFE_FBFD_FDFE_FDFF (641) which when combined with the constant derived in FIG. 25 for the first type of sign extension emulation gives a combined constant of 64′hFCFE_7A7C_FD7E_7D7F (642).

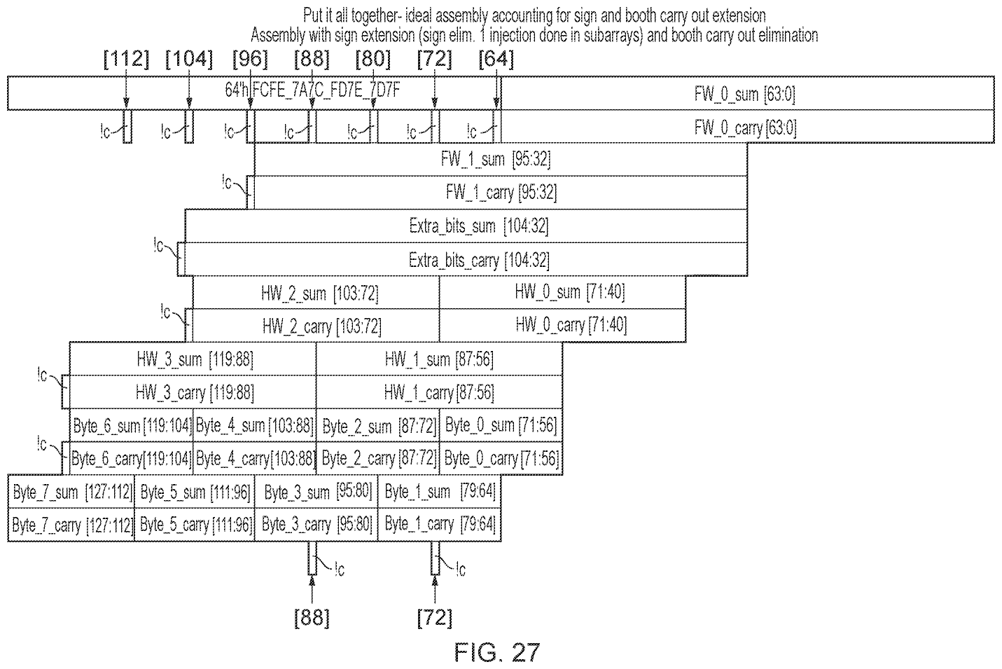

Hence, as shown in FIG. 27, putting together the assembly accounting for both the first and second types of sign extension emulations results in each of the sum/carry terms being treated by default as zero-extended, and the assembly including some additional assembly terms comprising: a single static constant 64′hFCFE_7A7C_FD7E_7D7F (642) and various one bit corrections !c (each derived from the msb+1 bits of the extended sum/carry terms of a respective adder sub-array as explained earlier and applied at the msb+1 position for that adder sub-array). The +1 corrections are not shown in FIG. 27 because they can be applied in the adder sub-arrays rather than in the result assembly addition.

This greatly reduces the complexity of the result assembly adder tree and reduces circuit fanout to limit the size of the critical timing path.

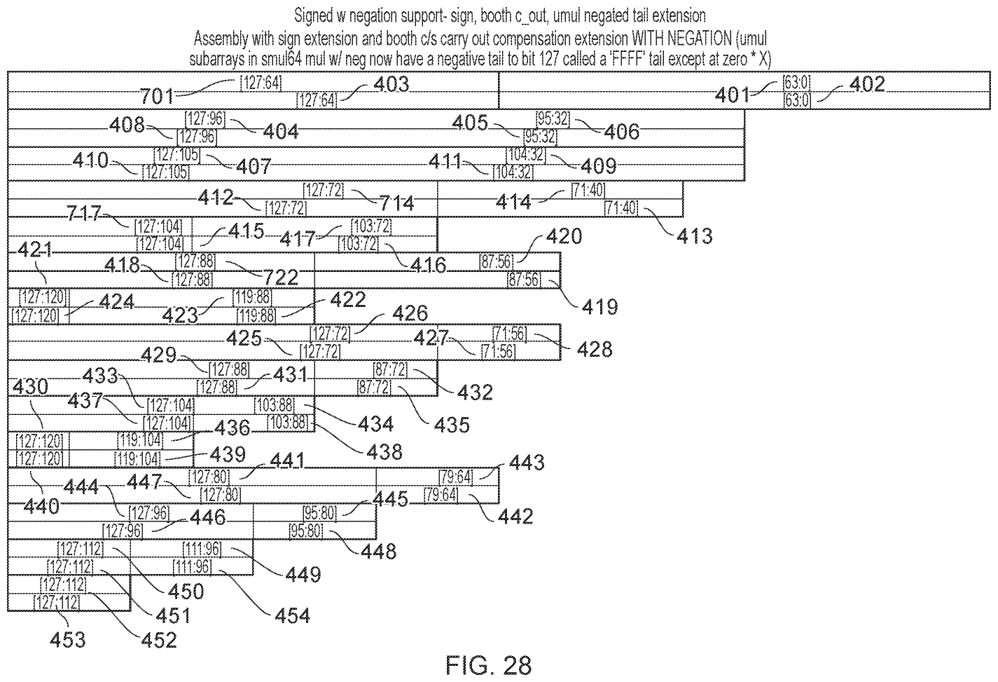

FIG. 28 then brings in the third type of sign extension used for a signed multiplication with negation for adder sub-arrays FW_0, HW_0, HW_1, HW_2 which consume portions of src_a, src_b that do not include either operand's sign bit. FIG. 28 shows the worst case result assembly if all of the first, second and third types of sign extensions are sign extended using the traditional approach.

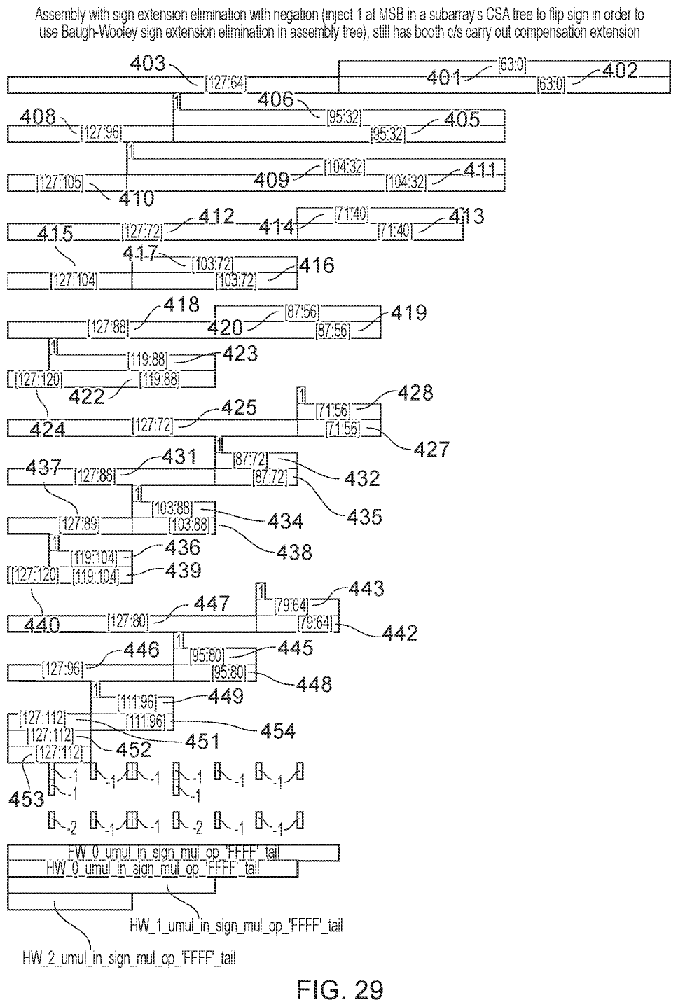

FIG. 29 shows elimination of the true sign extensions (first type of sign extension), using the same technique for the first type of sign extension emulation as shown in FIG. 25.

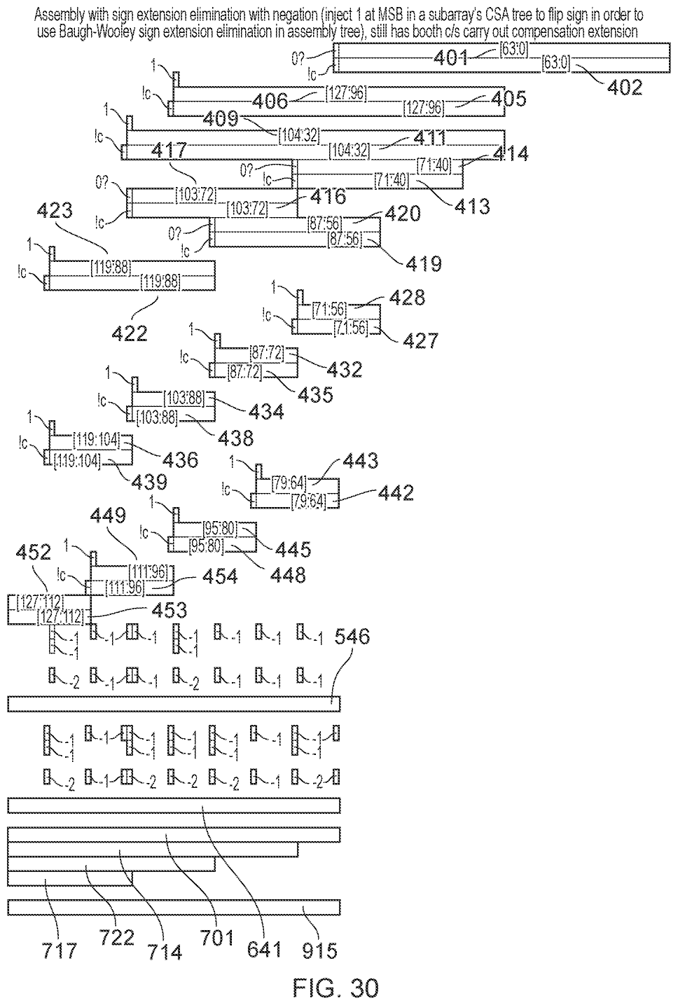

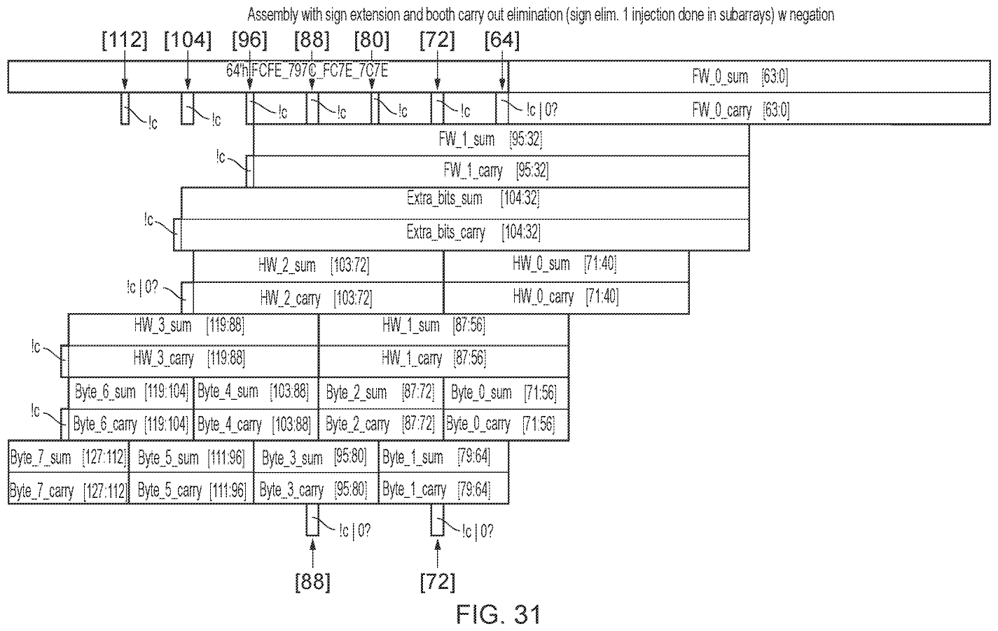

FIG. 30 shows elimination of the carry out sign extensions (second type of sign extension), using the same technique for the second type of sign extension emulation as shown in FIGS. 26 and 27.

As shown in FIG. 30, for eliminating the third type of sign extension (the tail of “FFFF . . . ” bits for dealing with the negation of outputs of an adder sub-array 56 operating on lower portions of the operands), this can be achieved by applying 1s at msb+1 position and all more significant bit positions (as represented by the various ‘FFFF’ tail terms shown at the lower part of FIG. 30) and injecting “0?” at the msb+1 bit position (where “0?” is 1 if either of the portions of src_a, src_b input to that sub-array 56 is zero and otherwise is 0). See the 0? corrections in columns 64, 72, 88 and 104 for adder sub-arrays FW_0, HW_0, HW_1, HW_2. The ‘FFFF . . . ’ tail terms for FW_0 (701), HW_0 (714), HW_1 (722), HW_2 (717) can be combined with the adjustment constants for dealing with the first and second type of sign extensions, to give a single static constant of 64′hFCFE_797C_FC7E_7C7E (915) which accounts for the −1 adjustments for eliminating the first type of sign extension (true sign extension), the −1 adjustments for eliminating the second type of sign extension (carry out sign extension), and the ‘FFFF . . . ’ adjustments for eliminating the third type of sign extension (sign extension of the negation of an unsigned result in signed multiply with negation).

Putting this all together, FIG. 31 shows the final result assembly addition, which involves adding the sum/carry terms from each of the adder sub-arrays 56, a single static constant 64′hFCFE_797C_FC7E_7C7E (915) as above which accounts for static parts of the corrections involved in emulating the first, second and third types of sign extension, and a number of 1-bit corrections including the !c terms for the second type of sign extension emulation and the 0? terms for the third type of sign extension emulation. As in FIG. 21 for the simpler example, where there is a !c correction and a 0? correction to be applied in the same column, these are ORed before the combined value is injected into the adder reduction tree for the result assembly addition.

Hence, from comparing FIG. 31 with FIG. 28, it can be seen that the sign extension emulations enable a significant reduction in circuit area and an improvement in performance, because a number of costly sign extension terms which would depend on specific adder sub-array results and so cause lengthy chains of dependent gates (not only in the row where the sign extension is included, but in the subsequent stages of the addition) are replaced with a static constant which is independent of the specific operands and/or some 1-bit corrections which can be computed relatively efficiently in parallel with the calculation of the sum/carry results for each adder sub-array. Therefore, this greatly improves performance and area-efficiency for the result assembly adder array 58.

It will be appreciated that not all examples need to use the sign extension emulation techniques for eliminating all three of the types of sign extension discussed here. For example, implementations which do not support negated multiply operations do not need to apply the third sign extension emulation. Similarly, implementations which add the carry and sum terms from a given adder sub-array before injecting the total into the result assembly addition do not need to apply the second sign extension emulation.

It will also be appreciated that the specific constants which are added in the result assembly addition to emulate the sign extensions will depend on the specific manner in which the subarray multiplier splits a larger multiplication into a number of smaller multiplications. The constants shown in FIGS. 15 to 31 are based on the specific sub-array mappings shown in FIGS. 12 and 22, but if the sub-arrays were mapped in a different manner onto the portions of the larger multiplication, the bit positions at which corrections are needed within the result assembly addition to emulate sign extensions would change, resulting in different values for the correction constants. The specific constants will depend on the specific manner in which the larger multiplication is allocated to a number of smaller multiplier arrays, but a skilled person will understand that the general principles for constructing these constants are as described above.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Concepts described herein may be embodied in a system comprising at least one packaged chip. The multiplication circuitry described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

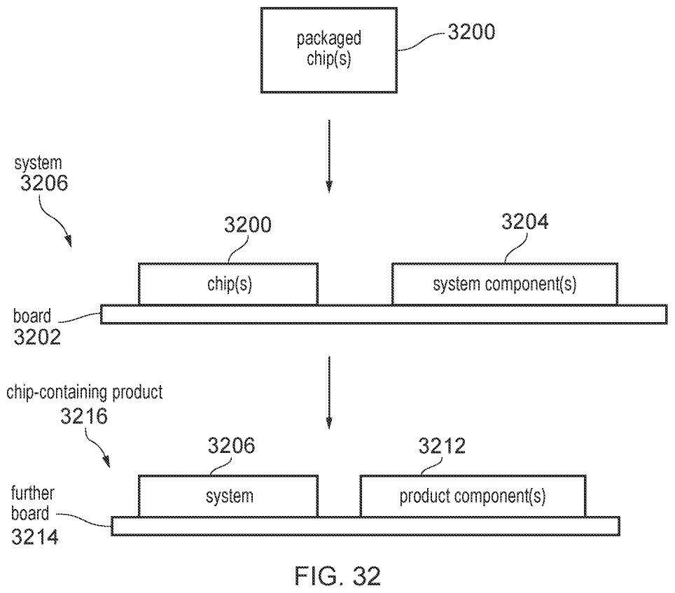

As shown in FIG. 32, one or more packaged chips 3200, with the multiplication circuitry described above implemented on one chip or distributed over two or more of the chips, are manufactured by a semiconductor chip manufacturer. In some examples, the chip product 3200 made by the semiconductor chip manufacturer may be provided as a semiconductor package which comprises a protective casing (e.g. made of metal, plastic, glass or ceramic) containing the semiconductor devices implementing the multiplication circuitry described above and connectors, such as lands, balls or pins, for connecting the semiconductor devices to an external environment. Where more than one chip 3200 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 3200 are assembled on a board 3202 together with at least one system component 3204 to provide a system 3206. For example, the board may comprise a printed circuit board. The board substrate may be made of any of a variety of materials, e.g. plastic, glass, ceramic, or a flexible substrate material such as paper, plastic or textile material. The at least one system component 3204 comprises one or more external components which are not part of the one or more packaged chip(s) 3200. For example, the at least one system component 3204 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 3210 is manufactured comprising the system 3206 (including the board 3202, the one or more chips 3200 and the at least one system component 3204) and one or more product components 3212. The product components 3212 comprise one or more further components which are not part of the system 3206. As a non-exhaustive list of examples, the one or more product components 3212 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 3206 and one or more product components 3212 may be assembled on to a further board 414.

The board 3202 or the further board 3214 may be provided on or within a device housing or other structural support (e.g. a frame or blade) to provide a product which can be handled by a user and/or is intended for operational use by a person or company.

The system 3206 or the chip-containing product 3216 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Some examples are set out in the following clauses:

1. Multiplication circuitry comprising:
a plurality of adder sub-arrays, each adder array to add a respective set of partial products to generate one or more sub-array result values representing a result of signed multiplication of a respective pair of portions of bits selected from a first operand and a second operand, the plurality of adder sub-arrays comprising separate instances of hardware circuitry, the plurality of adder sub-arrays having at least two separate enable control signals for independently controlling whether at least two subsets of the adder sub-arrays are enabled or disabled; and
a result assembly adder array to perform a result assembly addition to add a plurality of assembled values including the sub-array result values generated by the plurality of adder sub-arrays, to generate at least one multiplication result value representing a result of signed multiplication of the first operand and the second operand;
wherein for a sign-extension-emulated sub-array result value being added in the result assembly addition, the result assembly adder array is configured to perform sign extension emulation by:
   applying a default zero extension to the sign-extension-emulated sub-array result value regardless of a sign of the sign-extension-emulated sub-array result value, and
   performing the result assembly addition with at least one other of the plurality of assembled values having a value that, when added in the result assembly addition, emulates an effect of sign extending the sign-extension-emulated sub-array result value up to a bit position corresponding to the most significant bit of the at least one multiplication result value.

2. The multiplication circuitry according to clause 1, in which the at least one other of the plurality of assembled values comprises a static constant having a value selected independent of values of the first operand and the second operand.

3. The multiplication circuitry according to clause 2, in which the static constant is shared between a plurality of sign-extension-emulated sub-array result values, the static constant having a value which when added in the result assembly addition provides emulation of sign extension of each of those plurality of sign-extension-emulated sub-array result values.

4. The multiplication circuitry according to any of clauses 2 and 3, in which the at least one other of the plurality of assembled values also comprises a correction value injected relative to the sign-extension-emulated sub-array result value which, in combination with the static constant, emulates sign extending the sign-extension-emulated sub-array result value, the correction value comprising fewer bits than the static constant.

5. The multiplication circuitry according to any of clauses 1 to 4, in which the result assembly adder array is configured to perform a first type of sign extension emulation for a given sign-extension-emulated sub-array result value whose most significant bit is of lower significance than a most significant bit of the at least one multiplication result value, and which is generated by one of the adder sub-arrays based on a pair of portions of bits selected from the first operand and the second operand which includes a sign bit of at least one of the first operand or the second operand.

6. The multiplication circuitry according to clause 5, in which, for the first type of sign extension emulation, the result assembly adder array is configured to include in the plurality of assembled values added in the result assembly addition at least one assembled value providing a same result as applying:
a correction value of +1 at a bit position corresponding to a most significant bit of the given sign-extension-emulated sub-array result value; and
a constant having a value which represents subtraction of 1 at a bit position corresponding to the most significant bit of the given sign-extension-emulated sub-array result value.

7. The multiplication circuitry according to any of clauses 1 to 6, in which:
each adder sub-array is configured to generate, as said one or more sub-array result values, a sum term and a carry term which when added together would give the result of the signed multiplication of the respective pairs of portions; and
the result assembly adder array is configured to include, as separate assembled values in the plurality of assembled values being added in the result assembly addition, the sum term and the carry term for a given adder sub-array.

8. The multiplication circuitry according to clause 7, in which:
the result assembly adder array is configured to perform a second type of sign extension emulation to emulate a sign extension of a carry out caused by addition of the sum term and the carry term from the given adder sub-array.

9. The multiplication circuitry according to clause 8, in which for the second type of sign extension emulation applied to the sum term and the carry term from the given adder sub-array, the result assembly adder array is configured to include in the plurality of assembled values added in the result assembly addition:
a correction value at a bit position one place higher than a most significant bit of the sum term, the correction value having opposite bit value to the carry out caused by addition of the sum term and the carry term; and
a static constant having a value which represents subtraction of 1 at a bit position one place higher than the most significant bit of the carry term.

10. The multiplication circuitry according to clause 9, in which the result assembly adder array is configured to select whether the correction value is 0 or 1 based on carry out bits obtained by the given adder sub-array when generating the sum term and the carry term.

11. The multiplication circuitry according to any of clauses 1 to 10, in which:
the multiplication circuitry is configured to support a negated signed multiplication operation in which the at least one multiplication result value represents −1 times a result of signed multiplication of the first operand and the second operand; and
for the negated signed multiplication operation, the result assembly adder array is configured to perform a third type of sign extension emulation for a given sign-extension-emulated sub-array result value whose most significant bit is of lower significance than a most significant bit of the at least one multiplication result value, and which is generated by one of the adder sub-arrays based on a given pair of portions of bits selected from the first operand and the second operand where neither of the given pair of portions of bits selected from the first operand and the second operand includes a sign bit.

12. The multiplication circuitry according to clause 11, in which for the third type of sign extension emulation, the result assembly adder array is configured to include in the plurality of assembled values added in the result assembly addition:
a static constant having a value which represents adding 1s at all bit positions more significant than a most significant bit of the given sign-extension-emulated sub-array result value; and
a correction value at a bit position one place higher than a most significant bit of the given sign-extension-emulated sub-array result value, the correction value being 1 if one or both of the given pair of portions of bits selected from the first operand and the second operand is zero, and being 0 if one of the given pair of portions of bits selected from the first operand and the second operand is non-zero.

13. A system comprising:
the multiplication circuitry of any of clauses 1 to 12, implemented in at least one packaged chip;
at least one system component; and
a board,
wherein the at least one packaged chip and the at least one system component are assembled on the board.

14. A chip-containing product comprising the system of clause 13 assembled on a further board with at least one other product component.

15. A non-transitory computer-readable medium to store computer-readable code for fabrication of multiplication circuitry according to any of clauses 1 to 12.

16. Multiplication circuitry comprising:
partial product selection circuitry to select a plurality of partial products based on a first signed operand and a second signed operand; and
an adder array to add the plurality of partial products and a third signed operand; in which:
the adder array is configured to apply a default zero extension to the third signed operand regardless of a sign of the third signed operand, and the partial product selection circuitry is configured to adjust one of the partial products added by the adder array to emulate an effect of sign extending the third signed operand.

17. The multiplication circuitry according to clause 16, in which each partial product added by the adder array has a sign extension header to emulate sign extension based on a sign of the corresponding partial product; and
the partial product selection circuitry is configured to adjust the sign extension header associated with a least significant partial product based on the sign of the third signed operand, to emulate the effect of sign extending the third signed operand.

18. The multiplication circuitry according to clause 17, in which the partial product selection circuitry is configured to set the sign extension header associated with the least significant partial product to have a value which is 1 lower when the third signed operand is negative than when the third signed operand is positive.

19. A system comprising:
the multiplication circuitry of any of clauses 16 to 18, implemented in at least one packaged chip;
at least one system component; and
a board,
wherein the at least one packaged chip and the at least one system component are assembled on the board.

20. A chip-containing product comprising the system of clause 18 assembled on a further board with at least one other product component.

21 Computer-readable code for fabrication of multiplication circuitry according to any of clauses 16 to 18.

22. A computer-readable medium to store the computer-readable code of clause 21.

23. A non-transitory computer-readable medium to store the computer-readable code of clause 21.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. Multiplication circuitry comprising:
a plurality of adder sub-arrays, each adder array to add a respective set of partial products to generate one or more sub-array result values representing a result of signed multiplication of a respective pair of portions of bits selected from a first operand and a second operand, the plurality of adder sub-arrays comprising separate instances of hardware circuitry, the plurality of adder sub-arrays having at least two separate enable control signals for independently controlling whether at least two subsets of the adder sub-arrays are enabled or disabled; and
a result assembly adder array to perform a result assembly addition to add a plurality of assembled values including the sub-array result values generated by the plurality of adder sub-arrays, to generate at least one multiplication result value representing a result of signed multiplication of the first operand and the second operand;
wherein for a sign-extension-emulated sub-array result value being added in the result assembly addition, the result assembly adder array is configured to perform sign extension emulation by:
applying a default zero extension to the sign-extension-emulated sub-array result value regardless of a sign of the sign-extension-emulated sub-array result value, and
performing the result assembly addition with at least one other of the plurality of assembled values having a value that, when added in the result assembly addition, emulates an effect of sign extending the sign-extension-emulated sub-array result value up to a bit position corresponding to the most significant bit of the at least one multiplication result value.

2. The multiplication circuitry according to claim 1, in which the at least one other of the plurality of assembled values comprises a static constant having a value selected independent of values of the first operand and the second operand.

3. The multiplication circuitry according to claim 2, in which the static constant is shared between a plurality of sign-extension-emulated sub-array result values, the static constant having a value which when added in the result assembly addition provides emulation of sign extension of each of those plurality of sign-extension-emulated sub-array result values.

4. The multiplication circuitry according to claim 2, in which the at least one other of the plurality of assembled values also comprises a correction value injected relative to the sign-extension-emulated sub-array result value which, in combination with the static constant, emulates sign extending the sign-extension-emulated sub-array result value, the correction value comprising fewer bits than the static constant.

5. The multiplication circuitry according to claim 1, in which the result assembly adder array is configured to perform a first type of sign extension emulation for a given sign-extension-emulated sub-array result value whose most significant bit is of lower significance than a most significant bit of the at least one multiplication result value, and which is generated by one of the adder sub-arrays based on a pair of portions of bits selected from the first operand and the second operand which includes a sign bit of at least one of the first operand or the second operand.

6. The multiplication circuitry according to claim 5, in which, for the first type of sign extension emulation, the result assembly adder array is configured to include in the plurality of assembled values added in the result assembly addition at least one assembled value providing a same result as applying:
a correction value of +1 at a bit position corresponding to a most significant bit of the given sign-extension-emulated sub-array result value; and
a constant having a value which represents subtraction of 1 at a bit position corresponding to the most significant bit of the given sign-extension-emulated sub-array result value.

7. The multiplication circuitry according to claim 1, in which:
each adder sub-array is configured to generate, as said one or more sub-array result values, a sum term and a carry term which when added together would give the result of the signed multiplication of the respective pairs of portions; and
the result assembly adder array is configured to include, as separate assembled values in the plurality of assembled values being added in the result assembly addition, the sum term and the carry term for a given adder sub-array.

8. The multiplication circuitry according to claim 7, in which:
the result assembly adder array is configured to perform a second type of sign extension emulation to emulate a sign extension of a carry out caused by addition of the sum term and the carry term from the given adder sub-array.

9. The multiplication circuitry according to claim 8, in which for the second type of sign extension emulation applied to the sum term and the carry term from the given adder sub-array, the result assembly adder array is configured to include in the plurality of assembled values added in the result assembly addition:
a correction value at a bit position one place higher than a most significant bit of the sum term, the correction value having opposite bit value to the carry out caused by addition of the sum term and the carry term; and
a static constant having a value which represents subtraction of 1 at a bit position one place higher than the most significant bit of the carry term.

10. The multiplication circuitry according to claim 1, in which:
the multiplication circuitry is configured to support a negated signed multiplication operation in which the at least one multiplication result value represents −1 times a result of signed multiplication of the first operand and the second operand; and
for the negated signed multiplication operation, the result assembly adder array is configured to perform a third type of sign extension emulation for a given sign-extension-emulated sub-array result value whose most significant bit is of lower significance than a most significant bit of the at least one multiplication result value, and which is generated by one of the adder sub-arrays based on a given pair of portions of bits selected from the first operand and the second operand where neither of the given pair of portions of bits selected from the first operand and the second operand includes a sign bit.

11. The multiplication circuitry according to claim 10, in which for the third type of sign extension emulation, the result assembly adder array is configured to include in the plurality of assembled values added in the result assembly addition:
a static constant having a value which represents adding 1s at all bit positions more significant than a most significant bit of the given sign-extension-emulated sub-array result value; and
a correction value at a bit position one place higher than a most significant bit of the given sign-extension-emulated sub-array result value, the correction value being 1 if one or both of the given pair of portions of bits selected from the first operand and the second operand is zero, and being 0 if one of the given pair of portions of bits selected from the first operand and the second operand is non-zero.

12. A system comprising:
the multiplication circuitry of claim 1, implemented in at least one packaged chip;
at least one system component; and
a board,
wherein the at least one packaged chip and the at least one system component are assembled on the board.

13. A chip-containing product comprising the system of claim 12 assembled on a further board with at least one other product component.

14. A non-transitory computer-readable medium to store computer-readable code for fabrication of multiplication circuitry according to claim 1.

15. Multiplication circuitry comprising:
partial product selection circuitry to select a plurality of partial products based on a first signed operand and a second signed operand; and
an adder array to add the plurality of partial products and a third signed operand; in which:
the adder array is configured to apply a default zero extension to the third signed operand regardless of a sign of the third signed operand, and the partial product selection circuitry is configured to adjust one of the partial products added by the adder array to emulate an effect of sign extending the third signed operand.

16. The multiplication circuitry according to claim 15, in which each partial product added by the adder array has a sign extension header to emulate sign extension based on a sign of the corresponding partial product; and
the partial product selection circuitry is configured to adjust the sign extension header associated with a least significant partial product based on the sign of the third signed operand, to emulate the effect of sign extending the third signed operand.

17. The multiplication circuitry according to claim 16, in which the partial product selection circuitry is configured to set the sign extension header associated with the least significant partial product to have a value which is 1 lower when the third signed operand is negative than when the third signed operand is positive.

18. A system comprising:
the multiplication circuitry of claim 15, implemented in at least one packaged chip;
at least one system component; and
a board,
wherein the at least one packaged chip and the at least one system component are assembled on the board.

19. A chip-containing product comprising the system of claim 18 assembled on a further board with at least one other product component.

20. A non-transitory computer-readable medium to store computer-readable code for fabrication of multiplication circuitry according to claim 15.
